(19) United States
(12) Patent Application Publication
(10) Pub. No.: US 2013/0066688 A1
(43) Pub. Date: Mar. 14, 2013

(54) REGULATING DRIVER VEHICLE INPUT CHOICES IN FOR-HIRE VEHICLES

(71) Applicant: Michael Collins Pinkus, Alpharetta, GA (US)

(72) Inventor: Michael Collins Pinkus, Alpharetta, GA (US)

(73) Assignee: Frias Transportation Infrastructure LLC, Las Vegas, NV (US)

(21) Appl. No.: 13/417,163

(22) Filed: Mar. 9, 2012

Related U.S. Application Data
(60) Provisional application No. 61/532,469, filed on Sep. 8, 2011.

(51) Int. Cl. G06Q 10/06

(52) U.S. Cl. 705/7.41

(57) ABSTRACT

Sensors are deployed within a for-hire vehicle (taxi, limousine, or shuttles, for example) to measure changes in the environment of the for-hire vehicle. The sensors transmit data to a computing system that processes the data to determine the severity of the change in the environment. The aggregate of the severity of the data is used to determine if remedial action should be taken against the driver or owner/operator of the for-hire vehicle. Remedial action may include issuing a citation, fining the driver, or disabling a meter located within the for-hire vehicle. In some embodiments, venues (hotels, airports, nightclubs, or entertainment venues, for example) may restrict the ability of for-hire vehicles to pick up passengers where the aggregate of the severity of the data indicates the drivers may be engaging in careless, reckless or overly negligent driving behavior.

### CROSS-REFERENCE TO RELATED APPLICATIONS

This application claims the benefit of U.S. provisional application No. 61/532,469, filed Sep. 8, 2011 the disclosure of which is hereby incorporated by reference in its entirety.

### BACKGROUND

The present disclosure relates to the field of for-hire vehicles such as taxis, limousines, shuttles, buses or any other vehicle that provides shared transportation or transports one or more passengers between locations of the passengers' choice.

A for-hire vehicle (FHV) generally charges fares for transporting a passenger from one location to another. Some FHVs, such as taxicabs, operate with a meter. The primary purpose of a meter is to calculate fares for the passengers that hire the FHV. For example, the meter may charge an initial fee to start a trip and then may calculate a fee per every one-eighth mile traveled. The fares are generally displayed in a manner so that the passenger may view the calculation of the fare during the trip. A meter serves as a way to fairly and accurately calculate the total amount the passenger will be charged for the trip in the FHV. Meter-operated FHVs may differ from non-meter operated FHVs because in the former, the passenger's fare is calculated as the trip progresses while in the latter, the fare may be negotiated before the passenger is picked up.

The operation and maintenance of FHVs and meters is highly regulated. The entity charged with developing and enforcing the regulations (“regulatory agency”) for a jurisdiction generally imposes several requirements on operators of FHVs. For example, the regulatory agency may require the operator to obtain a certificate of public convenience and necessity (“CPCN”), which certifies that the operator is fit to operate a FHV or fleet of FHVs and that the vehicle or vehicles used to transport members of the public comply with certain minimum standards. As used herein, CPCN (or “certificate”) is meant to refer to the FHV owner's or operator's general certificate of license to operate as granted by the regulatory agency, jurisdiction, or governmental body, however denominated. Regulatory agencies may also issue permits or licenses to drivers of FHVs authorizing them to drive a FHV within the regulatory agency's jurisdiction for a period of time such as a year. In addition to certificates of public convenience and necessity and permits (or FHV drivers' licenses), regulatory agencies may also issue medallions to meter-operated FHVs. Medallions are generally unique within a single jurisdiction and may be identified by a serial number, or medallion number and are associated with only a single FHV at any one time. In order for the FHV to be operating within regulations, its associated medallion must generally be displayed so that enforcement officers and/or passengers may view the medallion. Regulatory agencies may also impose other restrictions on the operation of FHVs that apply to all operators and are not specifically associated with a CPCN, medallion or permit. These general regulations may apply to FHVs of a certain type, such as taxicabs, and may relate to passenger safety, the environment, or other concerns within the public interest.

### SUMMARY

In one embodiment, a method of a regulating a driver of a for-hire vehicle is disclosed. The method may comprise receiving, by a computer system, current sensor data providing information related to a passenger's experience as a rider in a for-hire vehicle describing a change in state of a for-hire vehicle from one or more sensors; associating, by the computer system, the sensor data with the for-hire vehicle; determining, by the computer system, a current qualitative value associated with the current sensor data; determining, by the computer system, whether to execute an action based at least in part on the determined current qualitative value and one or more past qualitative values associated with the for-hire vehicle, wherein the one or more past qualitative values have been determined based at least in part on received past sensor data; and executing the action. In other embodiments, the one or more sensors may be installed in the for-hire vehicle. Other embodiments may include sensor data that comprises an indication of, among other things, the acceleration of the for-hire vehicle, the interior temperature of the for-hire vehicle, the sound level in the interior of the for-hire vehicle, or the presence of smoke inside the for-hire vehicle. In some embodiments, the action may comprise, among other things: providing information regarding the quality of service prospective passengers of the for-hire vehicle may expect, a warning to the driver of the for-hire vehicle, preventing a meter associated with the for-hire vehicle to become first engaged, or issuing a fine to the driver of the for-hire vehicle. Example systems implementing these embodiments are also disclosed.

In another embodiment, a method of regulating a driver of a for-hire vehicle is disclosed. The method may comprise: receiving, by a computer system, a request for authorization to initiate a passenger fare from a for-hire vehicle meter installed in a for-hire vehicle; accessing, by the computer system, one or more driver input events associated with the for-hire vehicle, the one or more driver input events comprising an indication of readings from one or more sensors; determining, by the computer system, whether to authorize the for-hire vehicle meter based at least in part on the one or more driver input events; communicating, by the computer system, the authorization to the for-hire vehicle meter. Other embodiments may include sensor data that comprises at least one of: acceleration of the for-hire vehicle, the interior temperature of the for-hire vehicle, the sound pressure level in the interior of the for-hire vehicle, an indication of the breaking frequency of the for-hire vehicle, or an indication of the presence of smoke inside the for-hire vehicle. Example systems implementing these embodiments are also disclosed.

In another embodiment, a method of providing a quality of service rating associated with a for-hire vehicle is disclosed. The method may comprise: receiving, by a computer system, current sensor data providing information related to a passenger's experience as a rider in a for-hire vehicle describing a change in state of a for-hire vehicle from one or more sensors installed in the for-hire vehicle; associating, by the computer system, the sensor data with the for-hire vehicle; determining, by the computer system, a current qualitative value associated with the current sensor data; determining, by the computer system, one or more past qualitative values associated with the for-hire vehicle, wherein the one or more past qualitative values have been determined based at least in part on received past sensor data; and determining, by the computer system, a rating for the for-hire vehicle, the rating based at least in part on the aggregate of the one or more past qualitative values and the current qualitative value. In other embodiments, the method may also comprise executing, executing, by the computer system, an action based at least in part on the rating. The action may include, among other actions: providing a warning to the driver of the for-hire vehicle or preventing a meter associated with the for-hire vehicle to become first engaged. In other embodiments, the method may also comprise: receiving, by the computer system, a reservation request for a for-hire vehicle from a prospective passenger, the reservation request comprising a desired rating providing a minimum level of quality of service that is acceptable to the prospective passenger; generating, by the computer system, a reservation for a for-hire vehicle based on the reservation request wherein the reserved for-hire vehicle has a rating that satisfies the minimum acceptable level of quality of service; or dispatching, by the computer system, a for-hire vehicle based on the reservation. Example systems implementing these embodiments are also disclosed.

### BRIEF DESCRIPTION OF THE DRAWINGS

FIG. 1A illustrates one embodiment of a for-hire vehicle in communication with a regulatory agency computer system, a reservation and dispatch computer system, and a venue computer system over a network wherein the sensor manager and the event manager are part of a for-hire vehicle.

FIG. 1B illustrates one embodiment of a for-hire vehicle in communication with a regulatory agency computer system, a reservation and dispatch computer system, and a venue computer system over a network wherein the sensor manager and the event manager are part of a regulatory agency computer system.

FIG. 2A illustrates one embodiment of a FHV meter in communication with one or more sensors and a security token such as a key FOB, USB dongle, cryptography token, or hardware token, which comprises a sensor manager module and an event manager module.

FIG. 2B illustrates one embodiment of a FHV meter in communication with one or more sensors and a mobile device which comprises a sensor manager module and an event manager module.

FIG. 2C illustrates one embodiment of a FHV meter in communication with one or more sensors and a general purpose computer which comprises a sensor manager module and an event manager module.

FIG. 3 is a block diagram of one embodiment of a FHV in communication with one embodiment of regulatory agency computer system.

FIG. 4 is a data flow diagram illustrating one example of the temporal flow of data from one or more sensors to either a regulatory agency computer system or a FHV meter.

FIG. 5 is flowchart illustrating one example of the temporal flow of data for taking remedial action in response to receiving sensor data.

FIG. 6 is a flowchart illustrating one example of the temporal flow of data for first engaging a for-hire vehicle meter.

FIG. 7 illustrates one example of a user interface that may be used by a venue to define severity levels for one or more driver input events.

FIG. 8A illustrates an embodiment of two driver input models that may be used to regulate driver input choices: an agency model and a private party model, wherein the private party model corresponds to a venue, such as a hotel.

FIG. 8B illustrates one embodiment of a process for determining a driver's comfort rating based on an agency schema.

FIG. 8C illustrates one embodiment of a process of determining a driver's comfort rating based on a private party schema.

FIG. 9 illustrates an embodiment of two driver input models that may be used to regulate driver input choices: an agency model and a private party model, wherein the private party model corresponds to a fleet owner.

### DETAILED DESCRIPTION

Embodiments of the disclosure will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the disclosure. Furthermore, embodiments of the disclosure may include several novel features, no single one of which is solely responsible for its desirable attributes or which is essential to practicing the embodiments of the disclosure herein described.

### Overview

Rules and regulations related to the safety and convenience of FHVs have significant policy underpinnings as evidenced by the fact that virtually all jurisdictions in the world that regulate vehicle transport of passengers promulgate and attempt to enforce such rules and regulations. These rules and regulations are designed to promote adequate, convenient, fairly priced and safe FHV transport for the riding public, as well as fair competition among industry participants. Meaningful realization of these policy objectives, however, is difficult if not impossible without effective enforcement, which to date has been lacking in many jurisdictions. This results in harm to the riding public (for example, long waits or inability to obtain a taxi ride, risks of using unlicensed, unregulated, illegal and unsafe FHVs, price gouging, and even extortion), and to the FHV industry (for example, asymmetric competition from unlicensed, unregulated FHV operators, or legal ones operating in violation of the rules).

Currently, there is no automatic means for effective enforcement of the rules and regulations imposed on the operation of a FHV. The meter of the FHV will continue to operate even though the FHV may be operating outside the regulations imposed on FHVs by the regulatory agency. Furthermore, there is currently no means for monitoring the choices and behaviors of drivers of FHVs that may impact the safety and comfort of passengers or may violate the rules and regulations of the regulatory agency. Enforcement is limited to inspection by regulatory officers and is not automatic.

The present disclosure describes embodiments that allow regulatory or government agencies, as well as business owners and operators, the ability to monitor the behavior of a driver of a for-hire vehicle (FHV) such as a taxi, limousine or shuttle through the collection and analysis of driver input events. Driver input events, as used herein, relate to detectable actions of a driver that may be linked to the driver's input choices or decision making. For example, a driver input event may be the acceleration or deceleration of the FHV, which may be indicative of the driver's decision making with respect to safe driving or passenger comfort. A driver input event may also be, for example, an interior temperature reading of the FHV that is higher than a high temperature threshold, or lower than low temperature threshold, which may be indicative of the driver's decision making with respect to passenger comfort or fuel economy. Driver input events may also be related to collisions, interior sound levels, presence of smoke, presence of foul odors, breaking frequency, or fare paths (e.g., the route from passenger pick-up to passenger drop-off), for example.

As a driver drives a FHV, driver input events may be detected through the use of one or more sensors that are deployed in, on, or around the FHV. The sensors may communicate sensor data that describes a change in state due to a driver input choice (such as, for example, accelerating the FHV) to a computing system that acts as a sensor manager. When appropriate, the sensor manager may create a driver input event for the sensor data. Over time, the sensor manager may collect several sets of sensor data and may create associated driver input events.

The sensor manager may analyze the driver input events, or in other embodiments, may communicate the driver input events to a computing system that acts as a driver input event manager (or “event manager”) that may analyze the events. Analysis of the driver input events may include determining the seriousness of the event. For example, a temperature related driver input event may not be as serious as a collision related driver input event. As a result, in some embodiments, once the driver input events are created, they may be assigned a severity level by the sensor manager. In other embodiments, the sensor manager may communicate the driver input events to the event manager which may then assign a severity level to the driver input events. The severity of the driver input events may be based on a driver input model that is created by a regulatory agency charged with overseeing the operation of FHVs within its jurisdiction, or, in limited circumstances, the severity levels may be based on driver input model created by a private party. In some embodiments, severity levels may be a quantitative, numeric or point value. For example, acceleration events may receive a point value of 15 points and collision events may receive a point value of 200 points indicating the relative severity of the these two types of driver input events. In other embodiments, the driver input events may be assigned a severity level category. For example, the severity level may be “high”, “medium” or “low”, and acceleration events may receive a severity level of “low” whereas a collision event may receive a severity level of “high.”

Through the collection of driver input events and their associated severity levels, a pattern of behavior of the driver may be determined. Since the driver input events may vary in type and severity, a collection of driver input events may be used to advantageously summarize the overall driving behavior of a driver. In some embodiments the overall driving behavior of the driver may be given a comfort or safety level that provides a quick summary of the comfort and safety that may be expected of the driver. For example, comfort or safety levels may be descriptive such as “Very Comfortable,” “Comfortable,” “Somewhat Comfortable,” or “Not Comfortable.” Comfort and safety levels may also be ordinal alphanumeric characters such as “A” or “1” (indicating the highest level of safety and comfort) or “F” or “5” (indicating the lowest level of safety and comfort). In some embodiments, driver input events may be assigned points and threshold point values may be defined that indicate the comfort or safety level of the driver. For example, a comfort level of “Very Comfortable” may have a value of 1000 points or less, a comfort level of “Not Comfortable” may have a value of 1001-2500 points, and a comfort level of “Very Uncomfortable” may have a value of 2500 points. In some embodiments, the event manager may determine if the aggregation of collected driver input events indicates a need for an action. The action may be positive so as to encourage driver behavior resulting in comfortable and safe passenger trips, or the action may be negative so as to discourage behavior that may lead to uncomfortable or unsafe passenger trips. Positive actions may include, for example, granting a driver a special designation which the driver may display in the FHV to alert potential passengers that the driver consistently provides comfortable and safe trips. For example, the special designation may be displayed on a status indicator viewable from the exterior of the FHV or may be a certificate that the driver can display within the FHV. Negative actions may be referred to herein as “remedial actions” and may include, for example, a warning, a fine, a citation, or disablement of the driver's meter which prevents the driver from accepting new passenger fares. The remedial actions may also include notifying regulatory authorities of the need to revoke the driver's right to operate the vehicle such as the driver's permit, the medallion associated with the vehicle or the driver's certificate of public connivance and necessity “certificate.”

The embodiments described herein may be applied at different operational levels. For example, driver input events may be applied on a per driver basis or per driver group basis. Driver groups may be a group of drivers that are associated for regulatory enforcement purposes. For example, all of the drivers that operate taxis for a taxicab company may be associated as a driver group. When applied on a per driver basis, remedial actions may be directed to the driver. For example, if the aggregate of the driver input events indicates the driver is an unsafe driver, the remedial action may be that a regulatory agency issues a fine or citation against the driver. When applied on a per driver group basis, remedial actions may be directed to an entity responsible for the driver group. For example, if a driver group is defined for a taxicab company, if the drivers of the company's taxis exceed 1500 points per driver, the taxicab company might be issued a citation or fine, or the regulatory agency may suspend the company if the drivers exceed 6000 points per driver. By applying remedial actions at both the driver level and the driver group level, regulatory agencies may advantageously punish and potentially correct an undesired pattern of behavior in drivers or in the best practices of companies operating for-hire vehicles within their jurisdictions.

### Examples of System Architectures and Physical Embodiments

The examples of embodiments that follow are provided for illustrative purposes. Although functionality may be described with respect to one portion of an embodiment, the functionality may be, in a different embodiment, executed in a different portion. For example, in some embodiments, event analysis may occur in an on-vehicle computer system while in other embodiments the event analysis may occur at a regulatory agency computer system that may act as a central server computing system and is not located in or on the FHV.

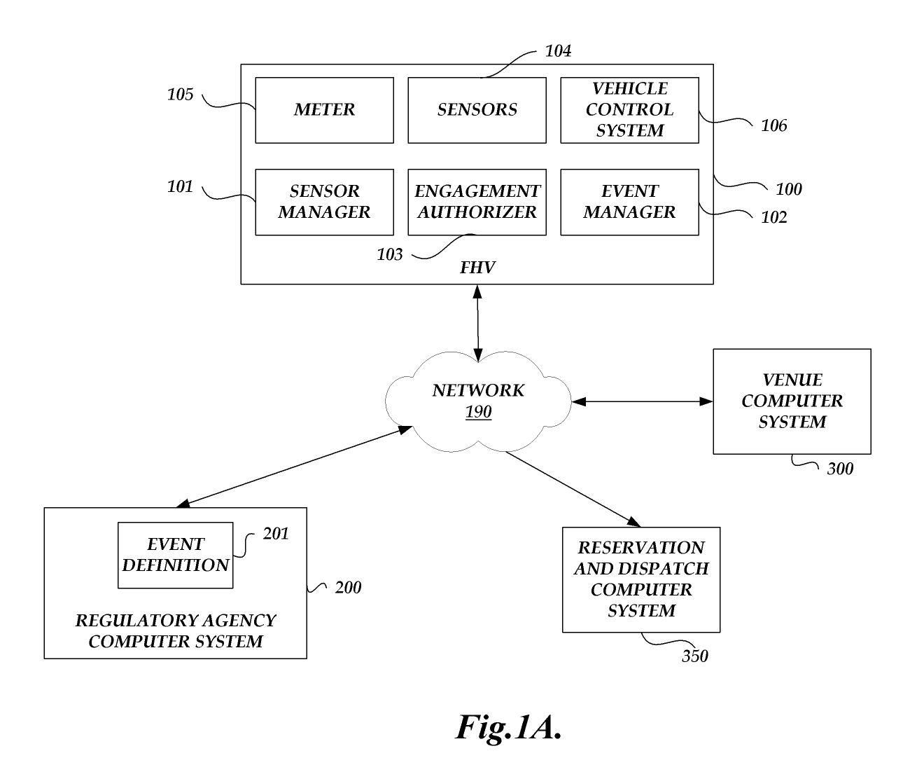

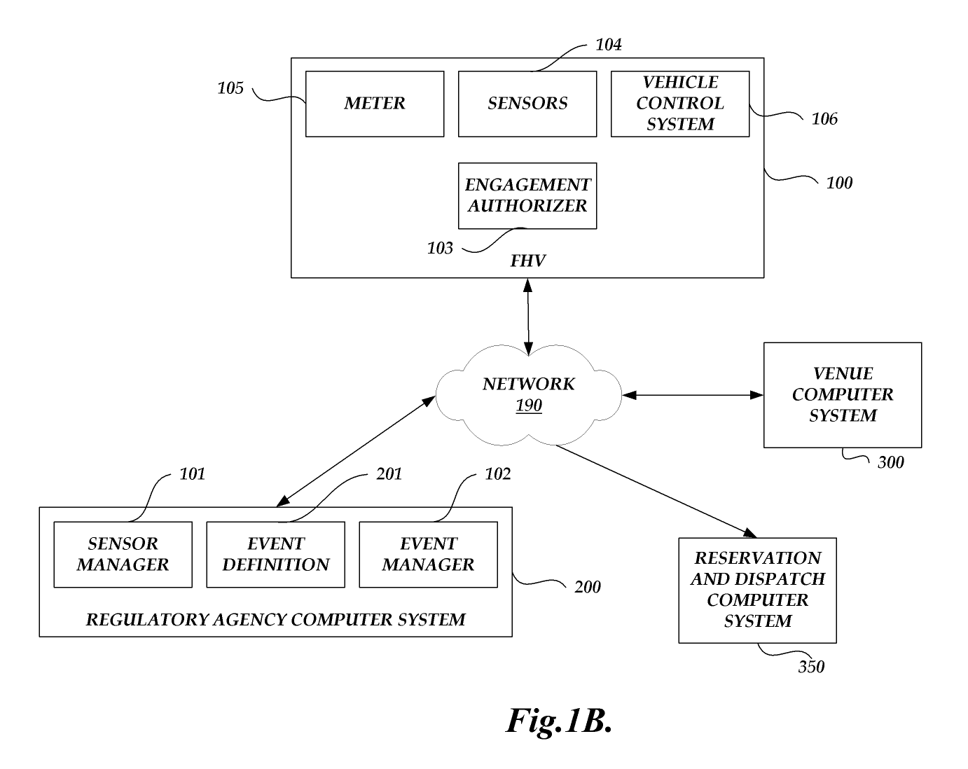

FIG. 1A illustrates one embodiment of a for-hire vehicle 100 in communication with a regulatory agency computer system 200 and a regulatory agency computer system 300 over a network 190. A for-hire vehicle (“FHV”) may be a commercial vehicle that can be hired by passenger to transport them from a pick-up location to a drop-off location. For example, the for-hire vehicle 100 may be a taxi, limousine or shuttle bus. The for-hire vehicle 100 may comprise one or more computing components and/or modules that facilitate the collection of fares or monitor and control the vehicle. For example, the for-hire vehicle 100 may include a FHV meter 105, one or more sensors 104, and a vehicle control system 106. In some embodiments, the FHV 100 may also include a sensor manager module or component (“sensor manager”) 101, event manager module or component (“event manager”) 102, and an engagement authorizer module or component (“engagement authorizer”) 103.

In some embodiments, the FHV 100 may comprise a sensor manager 101. The sensor manager 101 advantageously collects raw data from one or more sensors 104 that are deployed throughout the FHV 100. The sensor manager 101 may be a software module embodied in source code stored on a tangible computer medium that when executed causes a processor to receive or access raw sensor data and to generate driver input events using the sensor data. For example, the sensor manager 101 may be connected to the sensor for detecting acceleration, such as an accelerometer or gyroscope. The sensor manager 101 may receive all changes in acceleration from the sensor. It may then determine which changes in acceleration are significant enough to generate a driver input event. In some embodiments, the determination is made based on configuration parameters that are available to the sensor manager 101. The configuration parameters may be hard coded into the sensor manager 101 source code, provided through a configuration file, or provided through a console or user interface thereby by permitting a user to type in the configuration parameters. The configuration parameters may comprise a numerical value that when exceeded causes the sensor manager 101 to generate a driver input event for the sensor data.

In some embodiments, the sensor manager 101 may be a module or component that is directly connected to the FHV 100, but in other embodiments, the sensor manager 101 may be a module or component of the regulatory agency computer system 200. In such embodiments, the sensors 104 may communicate the sensor data to the regulatory agency computer system 200. This may be done, for example, through network 190. In other embodiments, the sensors 104 may be connected to a communications module such as the FHV meter 100, the vehicle control system or some other computer component or module that is part of FHV 100. In such embodiments, the communications module may then receive the sensor data from the sensors and transmit the sensor data to the regulatory agency computer system 200. Once received, the sensor manager may then analyze the raw sensor data to determine if any driver input events should be generated.

The sensor manager 101 may be in communication with one or more sensors 104. Generally, the sensors 104 may be any OEM or third party sensor capable of detecting a change in the environment that may affect passenger comfort or safety. For example, the sensors 104 may include accelerometers for detecting a change in acceleration of the FHV. The sensors 104 may also include location sensors that detect the FHV's current position such as a GPS sensor, for example. The sensors 104 may also include, smoke sensors, sound level sensors, temperature sensors, sonar sensors (for detecting the proximity of objects to the FHV), odor sensors, chemical sensors, radiation sensors, or any other sensor related to a passenger's experience as a rider in a FHV and describes a change in state.

In some embodiments, the sensors 104 may be incorporated within the vehicle control system 106. The vehicle control system 106 may be the computer system that monitors and controls the FHV. In some embodiments, sensor data may be extracted from the vehicle control system 106. For example, the vehicle computer system 106 may provide the acceleration/deceleration patterns of the FHV 100, or in other embodiments may provide raw data that could be used by the sensor manager 101 to calculate the acceleration/deceleration patterns of the FHV 100. For example, the vehicle control system may provide a velocity at time=t1, and a velocity at time=t2, that would be provided to the sensor manager 101 to calculate the acceleration. The vehicle control system 106 may also provide other sensor data such as, for example, volume sensor data. The vehicle computer system 106 may interface with the radio of the FHV and would know the current volume level originating from the radio of the FHV. The volume level could then be provided to the sensor manager 101. In some embodiments, the vehicle control system 106 may also provide data indicating whether the radio is on or off to the sensor manager 101. In other embodiments, data indicating the current radio station of the vehicle may be sent to the sensor manager 101. The vehicle control system 106 may also provide climate control data to the sensor manager 101. For example, the vehicle control system 106 may adjust the climate of the interior of vehicle to a temperature set by the driver, such as 78 degrees Fahrenheit. In some embodiments, the target temperature level set by the driver and the current temperature may be provided to sensor manager 101. For example, the driver may set a temperature target of 65 degrees and 65 degrees may be reported to the sensor manager 101 as the temperature set by the driver. In addition, the current temperature may be provided to the sensor manager 101. For example, although the driver may have set the target temperature to 65 degrees, the current temperature may be much warmer such as 75 degrees. Accordingly, the sensor manager 101 may receive a current temperature value from the vehicle control system 106. Additional types of sensor data provided to the sensor manager 101 may include, for example, data providing an indication of whether the vehicle stability control system has engaged, whether air bags have been deployed, additional data from the air bag sensors including measurements indicating how close the air bags were to deployment over a given time period, whether seatbelts are being used, and whether a seatbelt tension device has engaged. The types and format of sensor data may depend on the embodiment of the vehicle control system 106 and may vary from manufacturer to manufacturer. For example, the sensor data may include diagnostic or operation codes reported by the vehicle control system for the purpose of diagnosing problems with the vehicle.

Such sensor data originating from the vehicle control system may advantageously provide an indication of whether the driver has engaged in potentially risky or dangerous driving behavior. For example, when a driver takes turns sharply the stability control system of the vehicle may engage. Accordingly, if the sensor manager 101 receives sensor data that the stability control system engaged, it may determine that the driver is creating an uncomfortable experience for the passenger by taking turns too sharply. In other embodiments, data indicating that the temperature inside the vehicle is above 85 degrees, and the other data indicating that the driver has made no attempts to cool down the interior of the vehicle, may provide an indication that the driver is not providing a comfortable riding experience for the passenger. In addition, the state of the radio may be used to determine the comfort level of passengers. For example, volume level sensor data coming from the vehicle control system may indicate that a radio is being played too loudly and interrupting a peaceful passenger experience. In addition, an indication of whether the radio is on or off may be used to determine if the passenger is experience a comfortable trip, that is, a regulatory agency may enact a regulation prohibiting the use of a radio in a FHV and sensor data indicating whether the radio is on or off may be used to determine if the driver is abiding by the regulations. In other embodiments, the passenger may be able to permit radio use in the FHV via a switch accessible from the rear of the FHV (where a passenger traditionally sits). In such embodiments, if the passenger has indicated that the radio should not be played, sensor data indicating whether the radio is on or off may be used to generate driver input events. Further, the sensor data may also include radio station data in embodiments where the regulatory agency has determined that certain radio stations are prohibited.

In other embodiments, the sensors 104 may be external to the vehicle control system 106. The sensors 104 may be advantageously deployed within the FHV 100 any may provide sensor data to the sensor manager 101. In some embodiments, the sensors 104 may be permanently affixed to the vehicle. For example, one or more accelerometers may be deployed throughout the FHV that may communicate motion sensor data to the sensor manager 101. Other specialized sensors may be deployed throughout the FHV 100 and may include, among others things, smoke detectors, microphones, video recorders, still photographic cameras, proximity detectors, sound level sensors, chemical sensors, and temperature sensors.

In other embodiments, the sensors 104 may be portable computing devices capable of sensing movement or other environmental conditions and may communicate sensor data to the sensor manager. For example, a cell phone or mobile device that comprises accelerometers might detect the motion of the vehicle and communicate the motion sensor data to the sensor manager 101.

The FHV 100 may also comprise an event manager 102. The event manager 102 advantageously receives driver input events and analyzes the severity of the events. In some embodiments, the severity of the events may be determined through a point system where each type of driver input event is associated with a point value. For example, excessive acceleration events may be given a point value of 50 points, while an collision event may be given a point value of 500 points. In other embodiments, driver input events are assigned to severity category instead of a point value. For example, excessive acceleration events may be assigned to a severity category of “low” while a collision event may be assigned to a severity category of “high.”

In some embodiments, the event manager 102 may also determine an aggregate severity level for the for-hire vehicle based on the driver input events received for a period of time. The aggregate severity level may be a total point value. For example, if the event manager 102 received three events in the past year with a severity point value of 50 points and another event with a severity point value of 400 points, the aggregate severity level for the driver would be 550 points. In other embodiments, the event manager 102 may assign an aggregate severity level based on the number of events it has analyzed for a particular category. For example, if the event manager 102 received 10 low category events in the past year for a driver, it may assign an aggregate severity level of “medium” to a driver. On the other hand, if the event manager 102 received 2 low category events and 2 high category events in the past year for a driver, it may assign an aggregate severity level of “high” to the driver.

The event manager 102 may also execute a remedial action based on the aggregate severity level. A remedial action may be one or more actions that are taken to correct, deter or otherwise rectify a pattern of inappropriate driver behavior. A remedial action may be, for example, generating an alert that is sent to a regulatory agency computer system indicating that a citation should be issued to a particular driver. A remedial action may also include measures that prevent the FHV meter 105 from engaging passenger fares. Remedial actions may be less punitive in nature. For example, a remedial action may be generating an alert to the driver that serves as a warning.

To determine whether a remedial action should be taken, the event manager 102 may compare the aggregate severity level to a threshold. The threshold may be a point value that when surpassed, triggers the remedial action. For example, the event manager 102 may be configured to trigger a warning remedial action when the aggregate severity level of a driver exceeds 1000 points, and it may be configured to trigger a citation remedial action when the aggregate severity level of a driver exceeds 3000 points. The aggregate severity level threshold may be set programmatically, through a configuration file, or through a user interface such as console or graphical user interface. In some embodiments, entities other than the regulatory agency may be able to set the aggregate severity threshold for limited circumstances. For example, businesses where FHVs frequently pick-up passengers may wish to only allow drivers with few driver input events, or points, to pick up passengers at their place of business (or “venue”) as a courtesy to their customers. Accordingly, the regulatory agency may allow for a business to set an aggregate severity level threshold different (and likely more restrictive) than the regulatory agency. As a result, a driver may not be able to engage his meter at a venue, even though the driver may still accept passenger fares elsewhere within the regulatory agency's jurisdiction. For example, a regulatory agency may set the aggregate severity threshold level for the entire jurisdiction at 3000 points for the remedial action of not allowing the driver's meter to first engage. A hotel in the jurisdiction, however, may be able to set the aggregate severity threshold level for pick-ups at its hotel at 2000 points. Thus, those drivers that have accumulated more than 2000 points, but not more than 3000 points, may be able to first engage their meters at locations other than the hotel within the jurisdiction.

In some embodiments, the event manager 102 may be local to the FHV so that the aggregate severity level, or risk level, may be used by the FHV locally to facilitate a remedial action. Local facilitation of remedial actions may be advantageous in embodiments where the remedial action does not require the regulatory agency computer system's involvement. For example, when the remedial action is to prevent the meter from becoming first engaged, the event manager 102 may be connected directly to the FHV meter 105 so that the engagement authorizer component or module 103 may accesses the event manager 102 with minimal latency. In other embodiments, the event manager 102 may be located at the regulatory agency computer system. This may be advantageous in embodiments where the remedial action may require regulatory agency involvement. For example, when the remedial action is to issue a citation, the event manager 102 may be located at the regulatory agency computer system.

The event manager 102 may generate alerts when the risk level threshold is exceeded. The alerts may be to the driver of the FHV, or they may be to the regulatory agency or other entity that may wish to take remedial action. For example, if the remedial action is a warning, the event manager 102 may generate an alert in the form of an email that is sent to the email address of the driver so that the driver may be informed that he exceeded a risk level threshold. The alert may also be an email or other notice to the regulatory agency. This may be advantageous where the remedial action is a citation; an agent of the regulatory agency may receive an email, text message, or other notice that a citation should be issued to a driver.

In some embodiments, the FHV 100 may also comprise a FHV meter 105. A FHV meter may, in some embodiments, be a computing system that is configured to calculate the fares that are to be charged by passengers. In some embodiments, the FHV meter 105 may comprise or be connected to indicia that prospective passengers may use to determine that the FHV 100 is available to accept new passenger fares. For example, the FHV meter 105 may be connected to an exterior sign that displays “FOR HIRE” when the FHV is available for hire, or may have a light on the meter indicating that it is available for hire. When a passenger wishes to hire the FHV, the driver may “first engage” the meter. In some embodiments, the driver first engages the meter by pressing a button that initiates the fare. In most jurisdictions that regulate for-hire vehicles, a FHV cannot legally accept a passenger if the meter is not operable or is not able to become first engaged. In some embodiments, the FHV meter 105 may not become first engaged due to operating restrictions placed on the meter as described in applicants co-pending patent applications SYSTEMS AND METHODS FOR PAIRING OF FOR-HIRE VEHICLE METERS AND MEDALLIONS, application Ser. No. 13/225,352 filed Sep. 2, 2011 and SYSTEM AND METHOD FOR INDEPENDENT CONTROL OF FOR-HIRE VEHICLES, application Ser. No. 13/225,360 filed Sep. 2, 2011, both of which are incorporated by reference herein in their entirety. The FHV meter 105 may be dedicated computing system that connects to the FHV 100, or in other embodiments, may be a computing system that is integrated with the vehicle control system 106 of the FHV 100.

Some embodiments of the FHV 100 may comprise an engagement authorizer module or component (“engagement authorizer”) 103. The engagement authorizer 103 interfaces with the FHV meter 105 and provides authorization for the FHV meter 105 to become first engaged. When a driver accepts a passenger fare, the driver may press a button on the FHV meter 105 to first engage the meter. Before the meter engages and starts the fare, it may, in some embodiments, request authorization to engage the fare from the engagement authorizer 103. The engagement authorizer 103 may, for example, request the driver's risk level from the event manager 102 and compare it to the current risk level threshold for the current location of the FHV. The engagement authorizer 103 may determine the current location of the FHV by using an attached GPS module, for example.

In some embodiments, the FHV 100 may be in communication with a regulatory agency computer system 200. The regulatory agency computer system 200 may be a computer system that is operated and managed by a regulatory agency charged with regulating for-hire vehicles within a jurisdiction. In some embodiments, such as the embodiment of FIG. 1B, the regulatory agency computer system 200 may comprise the sensor manager 101 and/or the event manager 102 as opposed to the FHV comprising the sensor manager 101 and/or the event manager 102. The sensor manager 101 and the event manager 102 of the regulatory agency computer system 200 may function in the same or similar manner as the sensor manager 101 and the event manager 102 of the FHV 100.

As shown in FIG. 1A and FIG. 1B, in some embodiments, the regulatory agency computer system 200 may comprise an event definition component or module 201 (“event definition”). The event definition module 201 may manage the definition of which driver input events are to be assigned a severity level and the value of the severity level. For example, the event definition module 201 may comprise code that defines a driver input event with a name “extreme acceleration” and include the values that determine extreme acceleration as greater than 6 miles per hour-second. In some embodiments, the driver input events may be defined in a configuration file (such as a XML file for example) that is read by the event definition module 201. In other embodiments, the driver input events may be defined through a user interface such as a console interface or graphical user interface.

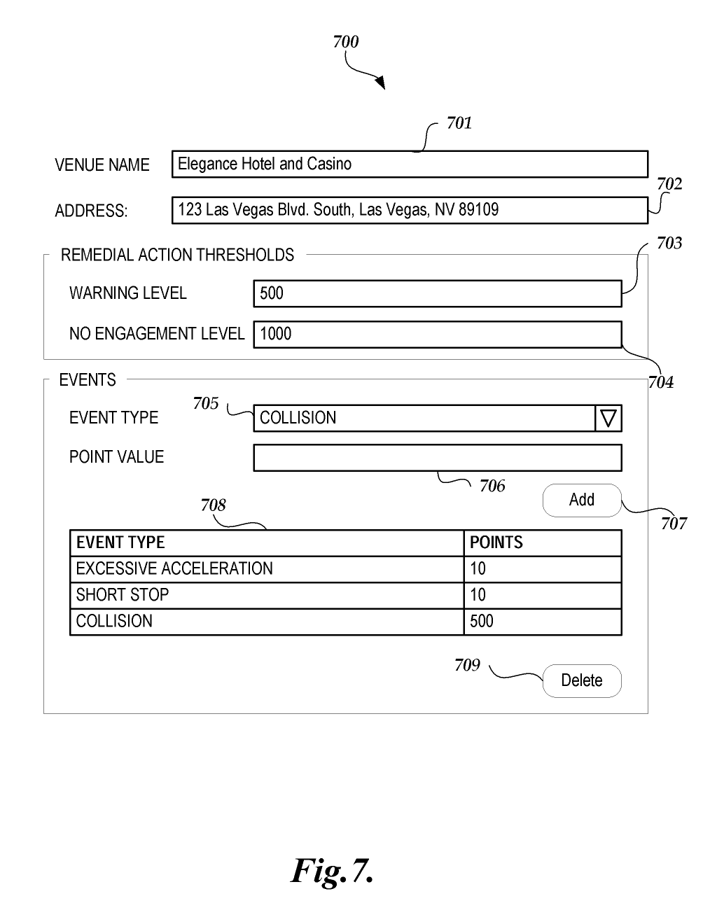

In some embodiments, the event definition module 201 may also be responsible for the definition of the severity levels for a particular driver input event. For example, the event definition module 201 may assign a point value of 25 points to an excessive volume event. Severity levels may be defined in a configuration file, such as a XML file or text file that is read by the event definition module 201. In other embodiments, the severity levels may be defined through a user interface such as a console interface or graphical user interface. The graphical user interface may be provided through a web portal or application service so that business may define severity levels for driver input events. An example of a user interface that a venue may use to defined severity levels for driver input events is described in further detail with respect to FIG. 7.

As shown in FIG. 1A and FIG. 1B, in some embodiments, the FHV 100 and/or the regulatory agency computer system 200 may be in communication with a venue computer system 300. The venue computer system 300 may be a computer system that is owned and/or operated by a business that may be interested in monitoring or controlling drivers of FHVs that may frequently pick up its customers. For example, the vendor computer system 300 may be owned and/or operated by a hotel, casino, airport, bus or train station, event or convention center, or nightclub. As described above, a business may be able to set risk level thresholds and/or driver input event severity levels so that it may provide safe, comfortable and convenient transportation options to its customers. In most cases, the business may set the risk level threshold lower than the thresholds established by the regulatory agency. For example, if the regulatory agency disables FHV meter engagements once the driver has accumulated 1000 points, a venue may decide to set a threshold of 700 points so that only “high quality” drivers may pick up passengers and engage their meters at the venue's location. Although the illustrative embodiments shown in FIGS. 1A and 1B show one venue computer system in communication with one FHV and one regulatory agency computer system, more than one venue computer system 300 may be in communication with more than one FHV 100 and the regulatory agency computer system 200.

The venue computer system 300 may comprise a web browser application that may allow a user of the venue computer system 300 to access a webpage provided by the regulatory agency computer system 200 that allows the user to define the risk level thresholds and the driver input severity levels for the venue. In other embodiments, the venue computer system 300 may execute a client application that allows a user to define the risk level thresholds and the driver input severity levels for the venue through a graphical user interface. For example, a user interface such as the one illustrated in FIG. 7 may be accessed through a web browser executing on the venue computer system 300 or a client application executing on the venue computer system 300. In other embodiments, the venue computer system 300 may execute an application that may create a configuration file defining the risk level thresholds and the driver input severity levels for the venue. The venue computer system 300 may also execute an application that facilitates the communication of the configuration to the regulatory agency computer system 200. For example, the venue computer system 300 may execute a text editor for creating the configuration file and may also execute a FTP client, or email client, for transmitting the file to the regulatory agency computer system 200. In some embodiments, the regulatory agency computer system may provide a webpage that accepts configuration file uploads.

As shown in FIG. 1A and FIG. 1B, in some embodiments, the FHV 100 and/or the regulatory agency computer system 200 may be in communication with a reservation and dispatch computer system 300. The reservation and dispatch computer system 350 may be a computer system operated by a FHV reservation and dispatch company and may receive requests to reserve a FHV from prospective passengers. In some embodiments, the reservation and dispatch computer system 350 may operate a web site where prospective passengers may access to reserve a FHV. The reservation and dispatch computer system 350 may also be connected to a phone system so that a prospective passenger may reserve a FHV by phone. In some embodiments, a third party acting on behalf of the prospective passenger may access the reservation and dispatch computer system 350 to reserve a FHV on behalf of the passenger. For example, a concierge at hotel, a doorman at a nightclub, or a guest services representative at an entertainment venue may access the reservation and dispatch computer system 350 on behalf of the potential passenger so that transportation for the potential passenger may be arranged.

In some embodiments, the reservation and dispatch computer system 350 may provide a comfort level selection option to the person reserving the FHV so that the passenger is ensured a fare with a FHV that is of the selected comfort level. For example, a potential passenger may access the reservation and dispatch computer system 350 via a phone. The reservation and dispatch computer system 350 may ask the potential passenger if they would like a certain level of comfort for their reservation. For example, it may ask the potential passenger if they would like a “Very Comfortable” ride, a “Comfortable” ride or “No Preference” as to the comfort level of the ride. Based upon the potential passenger's selection, and the comfort level rating of the FHVs currently available for reservation, the reservation and dispatch computer system 350 may then send a reservation and/or dispatch request to a FHV with a driver matching the requested comfort level. For example, if the potential passenger indicated that she would like a “Comfortable” ride, the reservation and dispatch computer system 350 may reserve and dispatch a FHV with a driver that is rated as giving a “Comfortable” level ride, or a “Very Comfortable” level ride.

In many cases, the wait for a “Very Comfortable” level ride may be longer than the wait for a “Comfortable” level ride or another other level of comfort lower than “Comfortable.” Thus, in some embodiments, the reservation and dispatch computer system 350 may determine an estimated wait time for each comfort level offered to the potential passenger thereby advantageously allowing the passenger to make a decision balancing the trade-off of wait time versus comfort. For example, the reservation and dispatch computer system 350 may determine that the wait for a “Very Comfortable” ride may be 15 minutes, but the wait for a “Comfortable” ride may be 5 minutes. Some potential passengers may be willing to wait the extra 15 minutes so that they may be assured a driver with a least a “Very Comfortable” level rating. Other potential passengers may need a ride sooner or may have no preference as to the comfort level of their ride. By offering estimated wait times, the reservation and dispatch computer system 350 advantageously provides the potential passengers options that best suit their needs.

In some embodiments, the reservation and dispatch computer system 350 may calculate estimated wait times based in part on the number of available FHVs for each comfort level and historical data that has been collected. For example, the reservation and dispatch computer system 350 may calculate estimated wait time for a driver rated “Very Comfortable” by first determining the number of “Very Comfortable” FHVs available. The number of available “Very Comfortable” FHVs may be determined by querying either the regulatory agency computer system 200 or the one or more FHVs 100 to determine the number of FHVs in operation at the query time that have a driver rated “Very Comfortable.” Then, the reservation and dispatch computer system 350 may compare the number of available FHVs to historical data. For example, the reservation and dispatch computer system 350 may have historical data that when 15 FHVs rated “Very Comfortable” are available, the average wait time is 8 minutes.

Although in the embodiments of FIGS. 1A and 1B, the reservation and dispatch computer system is shown as a separate computing system from the regulatory agency computer system, in some embodiments, the regulatory agency computer system 200 and the reservation and dispatch computer system 350 may be the same computer system. Further, while FIGS. 1A and 1B show one reservation and dispatch computer system 350 in communication with one FHV 100 and the regulatory agency computer system 200, more than one reservation and dispatch computer system 350 may be in communication with more than one FHV 100 and the regulatory agency computer system 200.

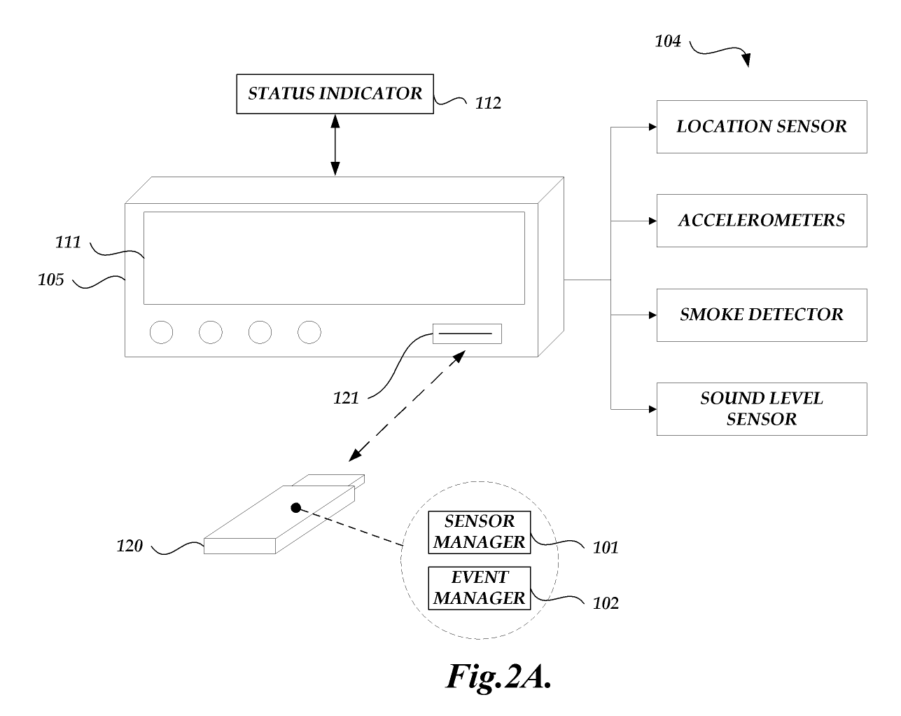

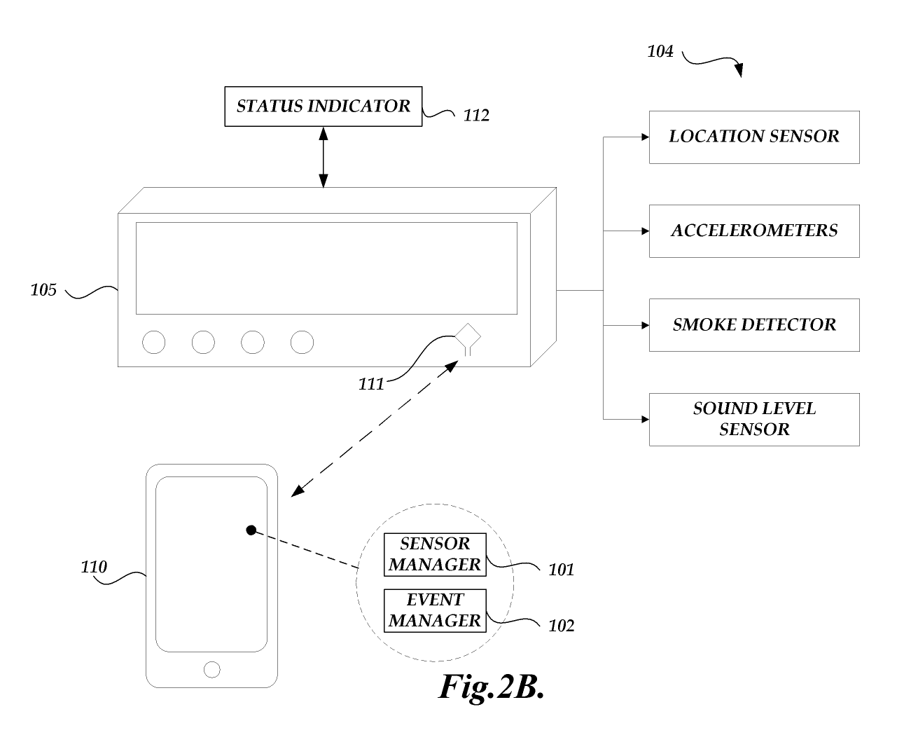

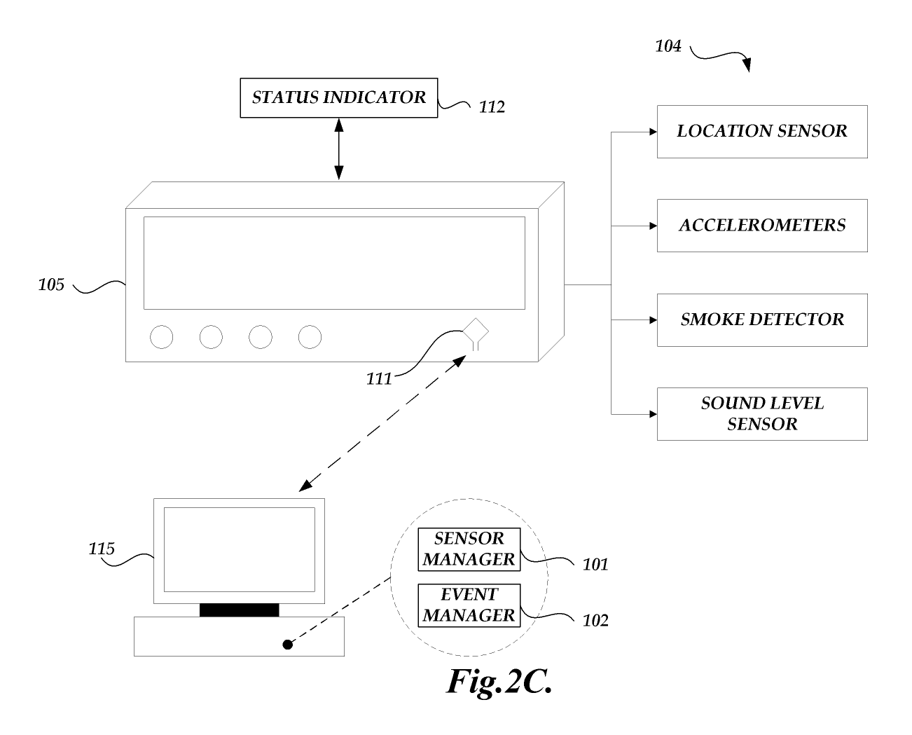

FIG. 2A, FIG. 2B and FIG. 2C illustrate various physical embodiments of a for-hire vehicle meter (“FHV meter”) 105 in communication with sensors 104 and alternative embodiments of computing systems that may comprise the sensor manager 101, the event manager 102 and the engagement authorizer 103. Although the embodiments described in FIG. 2A, FIG. 2B and FIG. 2C make reference to particular modules existing on particular components, the location of modules may vary from embodiment to embodiment without affecting the scope or functionality of the system. For example, the sensor manager 101 (not shown in FIGS. 2A-2C) may be embodied on FHV meter 105, token 120 (as shown in FIG. 2A), mobile device 110 (as shown in FIG. 2B) or a remote computer system 200 (as shown in FIG. 2C). Further, although FIG. 2A, FIG. 2B and FIG. 2C illustrate specific embodiments of computing systems that comprise computer media storing instructions that when executed perform the functions of the sensor manager 101, the event manager 102 and the engagement authorizer 103, additional or alternative computing systems may be used. In addition, in other embodiments, the FHV meter 105 may comprise computer media storing instructions that when executed perform the functions of the sensor manager 101, the event manager 102 and the engagement authorizer 103.

The embodiments of FIG. 2A, FIG. 2B and FIG. 2C illustrate that FHV meter 105 is in communication with four sensors 104: a location sensor, accelerometers (for detecting acceleration of the FHV), a smoke detector and a sound level sensor. Although the embodiments of FIG. 2A, FIG. 2B and FIG. 2C illustrate these four sensors in communication with FHV meter 105, the sensors could, in other embodiments, communicate directly with the alterative embodiments of computing systems that may comprise the sensor manager 101, event manager 102 and the engagement authorizer 103. Further, additional sensors providing additional sensor data may be in communication with the FHV meter 105 or the computing systems that may comprise the sensor manager 101, event manager 102 and the engagement authorizer 103.

The embodiments of FIG. 2A, FIG. 2B and FIG. 2C also illustrate the FHV meter 105 may comprise a display 111. The display 111 may, in some embodiments, provide passengers and drivers with information about the current fare. For example, the display 111 may show the current amount of the fare, or the current distance of the fare. In some embodiments, the display 111 may also show the current comfort level associated with the driver of the FHV, or may display a status associated with the current comfort level associated with the driver of the FHV. For example, if the driver is currently operating at a “Very Comfortable” comfort level, the display 111 may show “Very Comfortable Ride”, “Comfort Cab”, “A Rated Comfort”, or “A+Safety Rating,” In some embodiments, the FHV meter 105 may be connected to a status indicator 112. The status indicator 112, in some embodiments, may be viewable from the exterior of the FHV so that prospective passengers may receive a visual indication of the level of comfort they may expect from the FHV. For example, the status indicator 112 may be a taxi-top display affixed to the top of the FHV, or may be a display that is otherwise connected to the exterior of the FHV. Like the display 111, the status indicator 112 may show the current comfort level associated with the driver of the FHV, or may display a status associated with the current comfort level associated with the driver of the FHV.

FIG. 2A illustrates one embodiment of a for-hire vehicle meter (“FHV Meter”) 105 connected to several sensors 104, and a token 120. As shown in FIG. 2A, the token 120 may comprise a small, dedicated computer system configured to carry out the functionality of the sensor manager 101, the event manager 102 and the engagement authorizer 103. The token 120 may comprise a processor and memory. The token 120 may comprise a USB serial plug that may connect with FHV Meter 105 via USB port 121. In some embodiments, the engagement authorizer 103 is deployed on the token 120 thereby preventing the FHV Meter 105 from becoming first engaged when the token 120 is not connected to the FHV Meter 105. For example, when a driver wishes to first engage a passenger fare, the driver may press a button on FHV Meter 105. In response to the button press, the FHV meter 105 may communicate with engagement authorizer 103 to determine if the driver is permitted to engage passenger fares. When the token 120 is not connected to the FHV meter 105, the communication to the engagement authorizer 103 will fail and the FHV meter 105 will not engage.

In some embodiments, the regulatory agency may assign a token 120 to each driver that is permitted to operate a FHV within its jurisdiction. As drivers operate FHVs, they may be required to connect their token 120 with the FHV meter 105. As each token is portable and assigned to one driver, the accumulated driver input events follow the driver from FHV to FHV. For example, driver John Smith may be assigned a token with serial number “JS-123.” John Smith may work for ABC Cab Co. and may operate two FHVs, FHV-111 and FHV-222, depending on his shift needs. As John Smith operates two FHVs, he may accumulate driver input events on both vehicles, however, when the event manager 102 determines if John Smith has exceeded the aggregate severity level threshold, the events accumulated on both vehicles may be used since the token follows John Smith from vehicle to vehicle. In some embodiments, the driver's accumulated driver input events and aggregated severity level may be additionally stored at the regulatory agency computer system.

FIG. 2A also illustrates one embodiment of the FHV Meter 105 in communication with a location sensor. The location sensor may advantageously detect the current location of the FHV meter 105 or the FHV to which the FHV meter 105 is connected. In some embodiments, the location sensor may be used to advantageously determine whether the driver of the FHV is unnecessarily extending the length of the trip to increase the fare owed by the passenger. For example, the location sensor may send sensor data to the sensor manager 101 on a periodic basis that indicates the current position of the FHV. The sensor data may in turn compare the current position of the FHV to locations along an expected fare path (the likely path from pick-up to drop-off) to determine if the FHV is moving along the expected fare path. The expected fare path may be the shortest path in distance, the shortest path in time, or the path that results in the lowest fare. In some embodiments, the type of expected fare path may be configured and may have a default value. For example, the default for determining the expected fare path may be to use the fare path that results in the lowest fare, but a regulatory agency may be able to configure the sensor manager to use the shortest path in time or the shortest path in distance to determine the expected fare path. In some embodiments, the sensor manager may generate a driver input event when it has received several pieces of sensor data that indicate the FHV is not on an expected fare path. For example, suppose in one embodiment that a passenger has hired a FHV to take her from 123 Main St. to 456 6^{th} Ave. When the driver engages the fare, the sensor manager may determine an expected fare path. The fare path may be determined based on map data or historical fare data. For example, the sensor manager may determine that the expected fare path is to take Main St. north for 3 miles to 6^{th} Ave. and make a right, then travel 0.5 miles on 6^{th} Ave to 456 6^{th} Ave. Once the sensor manager determines the expected fare path, it may analyze received location sensor data from the location sensor to determine if the FHV is traveling along the expected Main-to-6^{th} Ave. path. If, for example, the sensor manager receives several pieces of location data that indicate the FHV is traveling south on Main St. (in the opposite direction from 6^{th}) it may generate a driver input event.

In some embodiments, exceptions to the expected path may be used by the sensor manager forgo generation of a driver input event in cases where a deviation from the expected fare path is justified. The justification may be, for example, to avoid traffic, accidents, poor weather or unfavorable conditions. Justifications for deviating from the fare path may be linked to the manner by which the expected fare path was determined. For example, if the expected fare path was determined based on time, then exceptions to the expected fare path may be permitted for alternative routes that decrease the expected time it would take to follow the expected fare path. In some embodiments, the sensor manager 101 may be in communication with a network, and it may query a traffic system computer to determine if there is traffic along the expected path. In such embodiments, it may suspend driver input event creation, or in other embodiments, calculate one or more alternative expected fare routes. The traffic system computer may be, for example, a traffic system computer operated by the regulatory agency, a government entity, or a commercial entity that monitors or reports traffic on roadways, such as Google Maps, for example.

FIG. 2B illustrates one embodiment of a FHV Meter 105 connected to several sensors 104, and a mobile device 110. As shown in FIG. 2B, the mobile device 110 may comprise an application that executes using the resources of the mobile device 110, such as the CPU, memory, data store, and I/O devices. The application may be configured to carry out at least some of the functionality of the sensor manager 101, the event manager 102 and the engagement authorizer 103. The mobile device 110 may comprise a wireless communication means such as a Wi-Fi port or RF antenna and may connect with FHV Meter 105 via wireless connection point 111. In some embodiments, the engagement authorizer 103 is deployed on the mobile device 110 thereby preventing the FHV Meter 105 from becoming first engaged when the mobile device 110 is not connected to the FHV Meter 105. For example, when a driver wishes to first engage a passenger fare, the driver may press a button on FHV Meter 105. In response to the button press, the FHV meter 105 may communicate with engagement authorizer 103 to determine if the driver is permitted to engage passenger fares. When the mobile device 110 is not connected to the FHV meter 105, the communication to the engagement authorizer 103 will fail and the FHV meter 105 will not engage. In some embodiments, the regulatory agency may assign a mobile device 110 to each driver that is permitted to operate a FHV within its jurisdiction. Accordingly, the driver input events accumulated by the driver in one FHV may follow him to the next FHV as described above with respect to FIG. 2A.

FIG. 2C illustrates one embodiment of a FHV Meter 105 connected to several sensors 104, and a remote computer system 115. As shown in FIG. 2C, the remote computer system 115 may comprise an application that executes using the resources of the remote computer system 115, such as the CPU, memory, data store, and I/O devices. The application may be configured to carry out at least some of the functionality of the sensor manager 101, the event manager 102 and the engagement authorizer 103. The remote computer system 115 may comprise a wireless communication means such as a Wi-Fi port or RF antenna and may connect with FHV Meter 105 via wireless connection point 111. In some embodiments, the engagement authorizer 103 is deployed on the remote computer system 115 thereby preventing the FHV Meter 105 from becoming first engaged when the mobile device 110 is not connected to the FHV Meter 105. For example, when a driver wishes to first engage a passenger fare, the driver may press a button on FHV Meter 105. In response to the button press, the FHV meter 105 may communicate with engagement authorizer 103 to determine if the driver is permitted to engage passenger fares. When the remote computer system 115 is not connected to the FHV meter 105, the communication to the engagement authorizer 103 will fail and the FHV meter 105 will not engage. In some embodiments, the remote computer system 115 may communicate with more than one FHV. In such embodiments, sensor data may be tagged with an identification code identifying the FHV or driver for which the sensor data should be attributed.

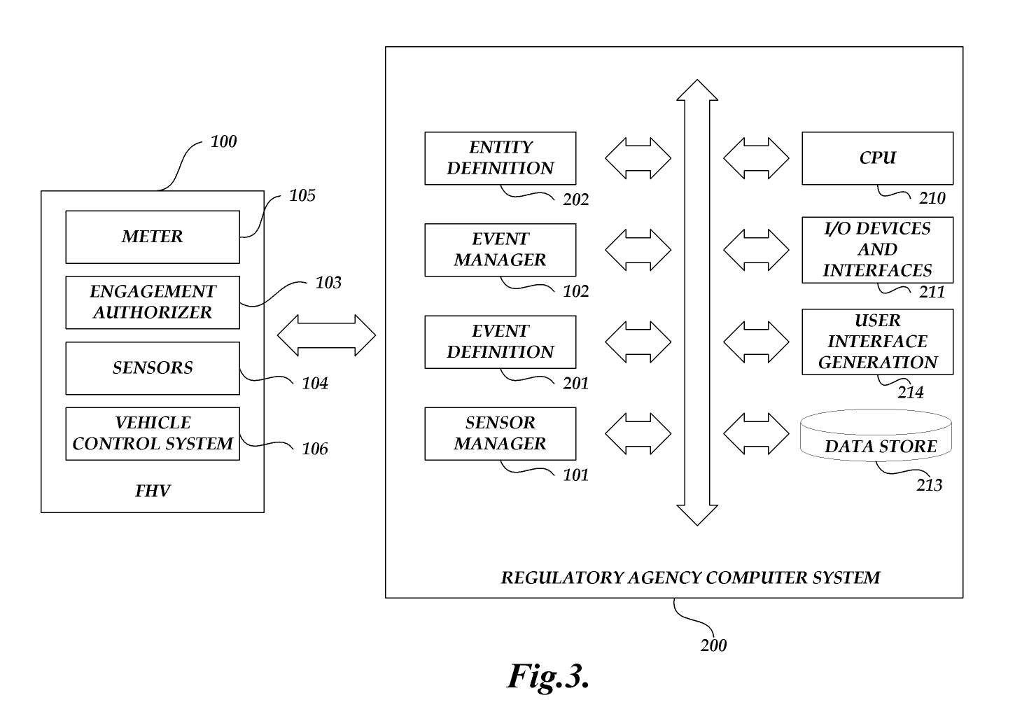

FIG. 3 is a block diagram of one embodiment of a FHV 100 in communication with one embodiment of regulatory agency computer system 100. In the embodiment of FIG. 3, the FHV 100 comprises a meter 105, an engagement authorizer 103, one or more sensors 104 and a vehicle control system 106. The regulatory agency computer system comprises a sensor manager 101, an event manager 102, a event definition module 201, an entity definition module 202, and a user interface generation module 214. In addition, the regulatory agency computer system comprises a CPU 210, I/O Devices and interfaces 211 and a data store 213.

In some embodiments, the regulatory agency computer system 200 may comprise an entity definition module 202. The entity definition module 202 may comprise instructions that when executed handle the configuration and management of drivers and driver groups. For example, the entity definition module 202 may provide for the configuration of driver identities to be registered with the regulatory agency. For example, John Smith may be a driver that has been granted a permit by the regulatory agency to drive a FHV within the agency's jurisdiction. The regulatory agency may have also assigned a token for John Smith to be use to operate his FHV or FHV meter. The entity definition module may provide code for registering John Smith and for assigning the token to him. The entity definition module 202 may also permit the definition of driver groups. A driver group may be a group of drivers that are associated for regulatory purposes. One example of a driver group may be all of the drivers that drive FHVs for a FHV fleet company. For example, if John Smith, James King and Walt White are all are drivers working for ABC Cab Co., the entity definition module 202 may provide for the definition of a driver group named “ABC Cab Co.” and assign John Smith, James King and Walt White to the ABC Cab Co. group. In some embodiments, the entity definition module 202 may accept driver and driver group definitions through a user interface generated by user interface generation module 214. In other embodiments, the entity definition module 202 may accept driver and driver group definitions through a configuration file, such as a plain text file or a XML file.

The regulatory agency computer system 200 may comprise a user interface generator 213. The user interface generator 214 may comprise code that causes the CPU to generate user interfaces for event definition, entity definition, reporting or other features of the system. The user interface generator 214 may generate user interfaces as web pages that are sent to requesting web browsers. Further, the user interface generator 214 may create an object or other code that instructs a client application to render a user interface on a client computer.

### Examples of Embodiments of Data Flow

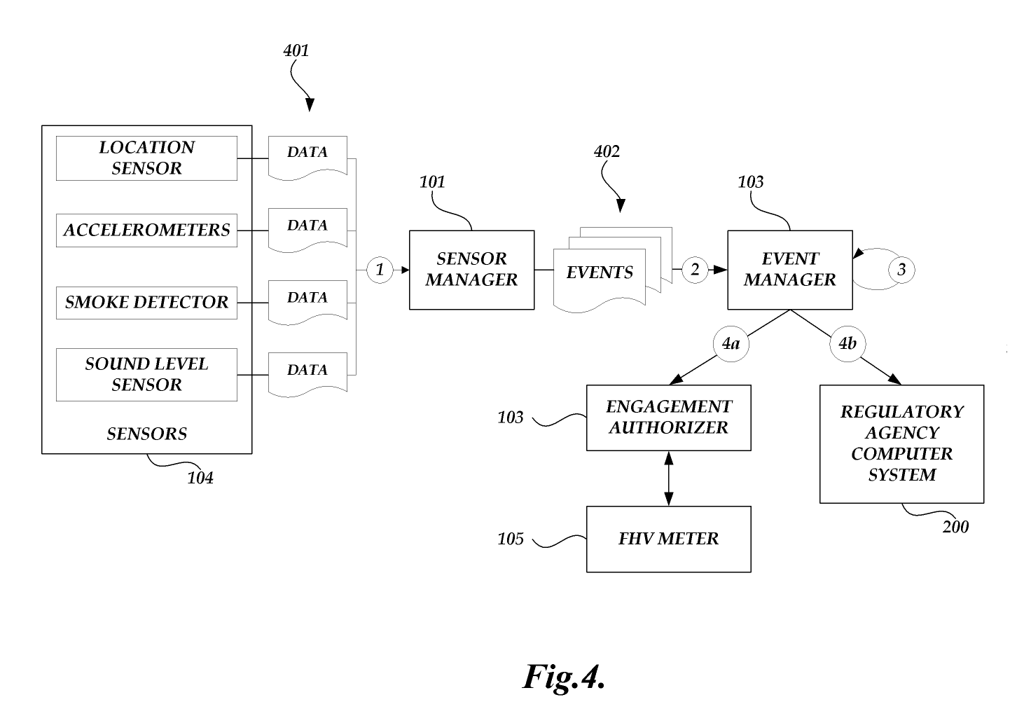

FIG. 4 is a data flow diagram illustrating one example of the temporal flow of data from one or more sensors to either a regulatory agency computer system or a FHV meter. The flow of data starts with the sensor 104 which sends sensor data 401 to the sensor manager at step 1. The sensor data 401 may be communicated in various formats and may depend on the specification of each sensor as defined by the sensor's manufacturer. The sensor manager 101 may comprise code that is capable of interpreting the sensor data 401 based on the manufacturer defined format. In some embodiments, the sensors 104 may transmit the sensor data 401 through a wireless connection. The sensor data 401 may comprise raw data related to the sensor. For example, if the sensor data 401 relates to an acceleration sensor, it may include data such as the detected velocity at first time and a detected velocity and a later, second time. The data may also include an acceleration value.

Once the sensor manager 101 receives the sensor data 401, it may extract and interpret the data. For example, if the sensor manager 101 determines that the sensor data 401 is significant enough to warrant the generation of a driver input event, it may generate it and send it to the event manager 103 at step 2. The sensor manager 101 may determine that the sensor data 401 is significant based on configuration data that defines acceptable and unacceptable sensor data values. For example, the sensor manager 101 may be configured so that sensor data for sound exceeding 90 dB requires the generation of a driver input event. Thus, when the sensor manager 101 receives sensor data 401 that indicates a level of 100 dB the sensor manager 101 may generate a driver input event 402.

Once the event manager 103 receives the driver input events, it may analyze the events at step 3. The analysis may include assigning a severity level to the received driver input event. For example, if the event manager receives a driver input event for the presence of smoke, it may assign a “medium severity” category to the driver input event. In some embodiments, the event manager analyzes received driver input events on demand. This may occur in embodiments where the remedial action is to prevent the first engagement of a FHV meter if the aggregate of driver's severity levels for his driver input events exceeds the risk threshold for the jurisdiction or pick-up location. When events are analyzed on-demand, the event manager may maintain a list of current driver input events and may calculate the aggregate of driver's severity levels. On-demand event analysis may be advantageous in embodiments where the severity level associated with a driver input event varied depending on the location where a first engagement is requested. For example, a hotel may define its own severity levels for various driver input events and may also define its own risk threshold level. The hotel's severity levels and risk threshold level may be different, and more restrictive, than the regulatory agency's defined levels. Thus, on-demand event analysis may be advantageous because the analysis of the events depends on the current location of the for-hire vehicle.

The data resulting from the event analysis may flow to different computing systems depending on the embodiment or the remedial action that has been defined for monitoring driver behavior. In step 4a, the data resulting from event analysis may flow to the engagement authorizer. This data flow may be appropriate in embodiments where the remedial action is to prevent the first engagement of the FHV meter 105. For example, if a driver wishes to engage a passenger fare, the driver may request to initiate a passenger fare by depressing a button on his FHV meter 105. In response to the request to initiate the passenger fare, the FHV meter 105 may request authorization to engage from the engagement authorizer 103. The engagement authorizer may use the data resulting from the event analysis to determine whether to send authorization back to the FHV meter 105.

In step 4b, the data resulting from the event analysis may flow to the regulatory agency computer system 200. This data flow may be appropriate in embodiments where the remedial action is to issue a citation or fine to the driver. It may also me appropriate for warning remedial actions. For example, a driver may be warned upon reaching a risk threshold level of five “medium severity” driver input events. When event manager 103 receives five “medium severity” driver input events, it may pass the result of its event analysis to the regulatory agency computer system 200. The regulatory agency computer system 200 may then, in turn, issue a warning in the form of an email or text message to the driver. The regulatory agency computer system 200 may also send a warning message to the driver's FHV meter 105 that may be displayed on the meter, in some embodiments.

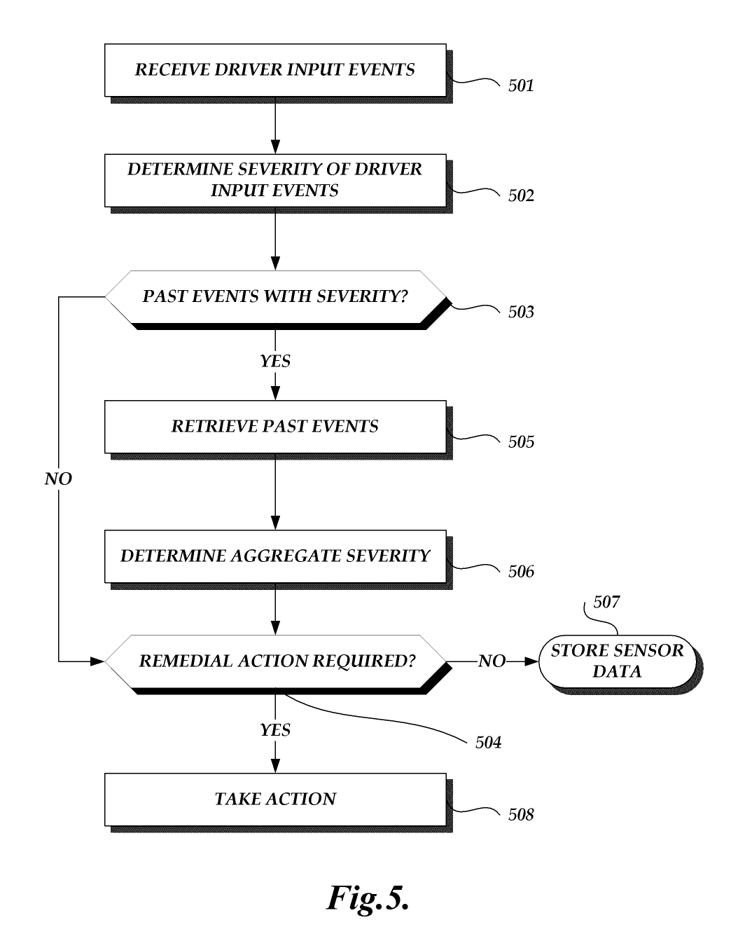

FIG. 5 is flowchart illustrating one example of the temporal flow of data for taking remedial action in response to receiving sensor data. At box 501, the event manager 102 receives one or more driver input events. For each received event, the event manager 102 may determine the severity of the events. The severity may be, for example, a point value, or in other embodiments may be a category. The event manager 102 may then determine if it has received other driver input events. If not, processing may proceed to box 504 where the event manager 102 may determine if remedial action is required based on the severity of the received driver input event. If other driver input events have been analyzed, the event manager 102 may retrieve the past events at box 505. The event manager 102 may determine the aggregate severity for all the driver input events it has received that are may still be attributed to the driver at box 506. The determination may be based on a point system. For example, each driver input event may be assigned an associated value, and the event manager 102 may determine the aggregate severity level by adding the point values for each driver input event.

At box 504, the event manager 102, may determine if remedial action is required. The determination may be based at least in part on risk threshold levels defined by the regulatory agency or one or more venues where FHVs under the regulatory agency's control may pick up passengers. In embodiments where the remedial action is to prevent the first engagement of the FHV meter, the event manager 102 may first determine the current location of the driver or FHV. Based on the current location, the event manager may determine the applicable risk threshold and apply the driver's aggregate severity to the risk threshold. For example, a casino may define a risk threshold to prevent engagement of a FHV meter at 5000 points. The Las Vegas airport may define a risk threshold of 6000 points to prevent first engagement, and the regulatory agency may define a jurisdiction wide risk threshold of 10,000 points to prevent first engagement. A driver may have 5500 points. When the driver is attempts to engage a passenger fare at the casino, the determination at box 504 will first determine that the driver is at the casino and then determine that remedial action is required because the driver's point value of 5500 points exceeds the risk threshold of 5000 points set by the casino. If the driver attempts to engage a passenger fare at the airport, the determination of box 504 will first determine that the driver is at the airport and then determine that remedial action is not required because the driver's point value of 5500 points does not exceed the risk threshold for the airport. When the driver attempts to engage a passenger fare somewhere other than the casino or the airport, the determination of box 504 will first determine that the driver is not at the casino or airport (or any other venue that has defined its own risk threshold) and will determine that remedial action is not required because the driver's point value of 5500 points does not exceed the regulatory agency's default risk threshold value of 10,000 points.

Once the event manager 102 determines that remedial action is required, processing moves to box 508 where the remedial action is executed. In some embodiments, the remedial action may be warning sent to the driver. In other embodiments, an alert may be transmitted to the regulatory agency computer system 200 so that a citation or fine may be issued. In extreme cases, an alert may be sent to the regulatory agency so that the driver may be taking into custody. If remedial action is not required, the event manager 102 may store the received sensor data or driver input event so that it may be used in aggregate calculations (at box 506) if the driver receives another driver input event in the future.

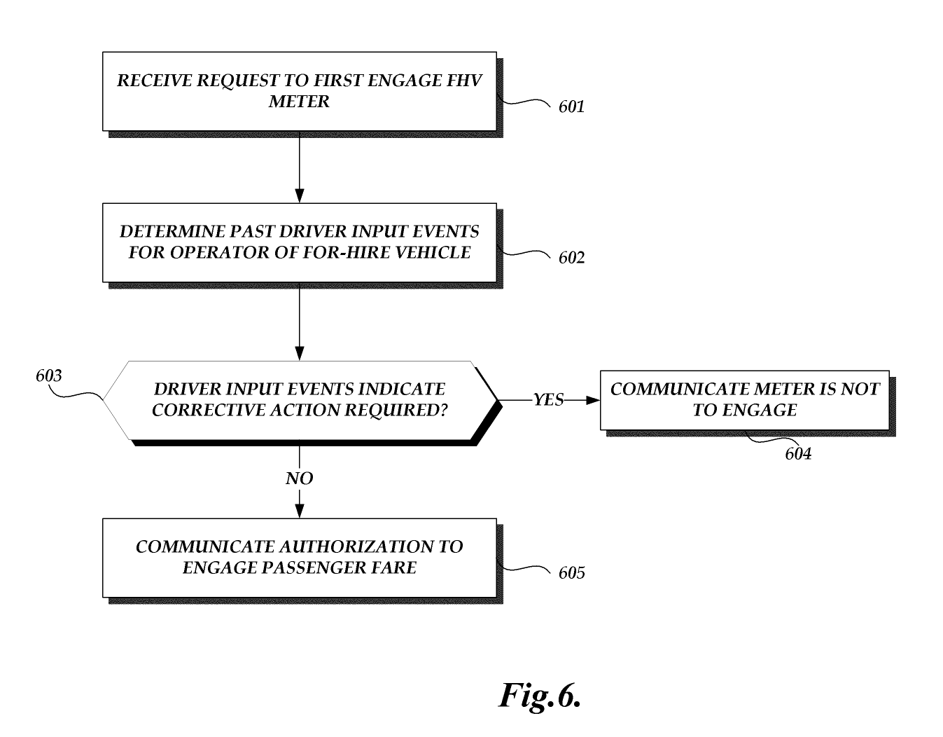

FIG. 6 is a flowchart illustrating one example of the temporal flow of data for first engaging a for-hire vehicle meter. At box 601, the engagement authorizer 103 receives a request to first engage a FHV meter. Once the request is received, processing moves to box 602 where the event manager 102 determines the past driver input events for the driver (or operator) of the FHV. The determination of box 602 is similar, or substantially similar, to the determination of box 506 of FIG. 5. At box 603, the event manager 102 may determine whether corrective action is required. The determination made at box 603 may be similar, or substantially similar, to the determination made at box 504 of FIG. 5. If corrective action is required, processing moves to box 604 where the engagement authorizer 103 responds to the request to engage the FHV meter in the negative. If, however, corrective action is not required, processing moves to box 605 where the engagement authorizer 103 responds to the request to engage the FHV meter in the affirmative.

### Examples of Embodiments of User Interfaces

FIG. 7 illustrates one example of a user interface that may be used by a venue to define severity levels for one or more driver input events. The user interface of FIG. 7 may be embodied in one or more web pages or embodied as user interfaces of a computer application that executes on venue computer system 300 that may be in communication with regulatory agency computer system 200. The user interface of FIG. 7 are meant as example and may include more or less user interface elements as desired.

FIG. 7 illustrates one example of event definition user interface 700. Event definition user interface 700, in some embodiments, may include venue name field 701 allowing a user to input a venue name associated with the remedial thresholds and driver input event severity values. The user interface 700 may also include address field 702. The address entered in to address field 702 may be used by engagement authorization module 103 to determine the current remedial action threshold value when the FHV 100 attempts to first engage a passenger fare. For example, if the FHV 100 is at, or substantially close to, 123 Las Vegas Blvd. South, the threshold values defined in user interface 700 may be used to determine if the fare should be engaged.

The user interface 700 may also permit the user to define remedial action thresholds for a warning level 703 and a no engagement level 704. The values entered may be used to determine when certain remedial actions are to be taken with respect to the venue at the address 702. For example, a user may define the warning level to be 500 points and the no engagement level to be 1000 points. Thus, a driver who arrives at 123 Las Vegas Blvd. South that has accumulated less than 500 points will not receive a warning and will be able to engage his FHV meter, however, a driver who arrives at 123 Las Vegas Blvd. South that has accumulated 700 points will be able to engage his FHV meter, but will receive a warning that his aggregate risk level is approaching the no engagement threshold. The warning may be in the form of an alert (an email or text message for example), or it may be a message the displays on the driver's FHV meter. A driver who has exceeded 1000 points will not be able to engage his meter.

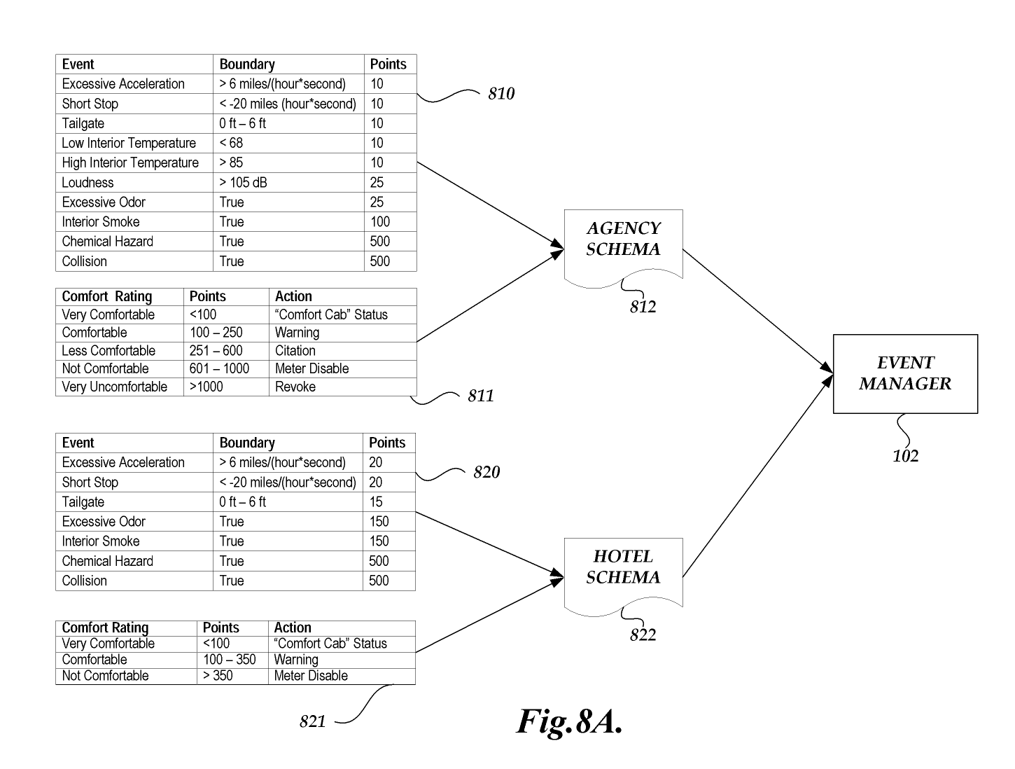

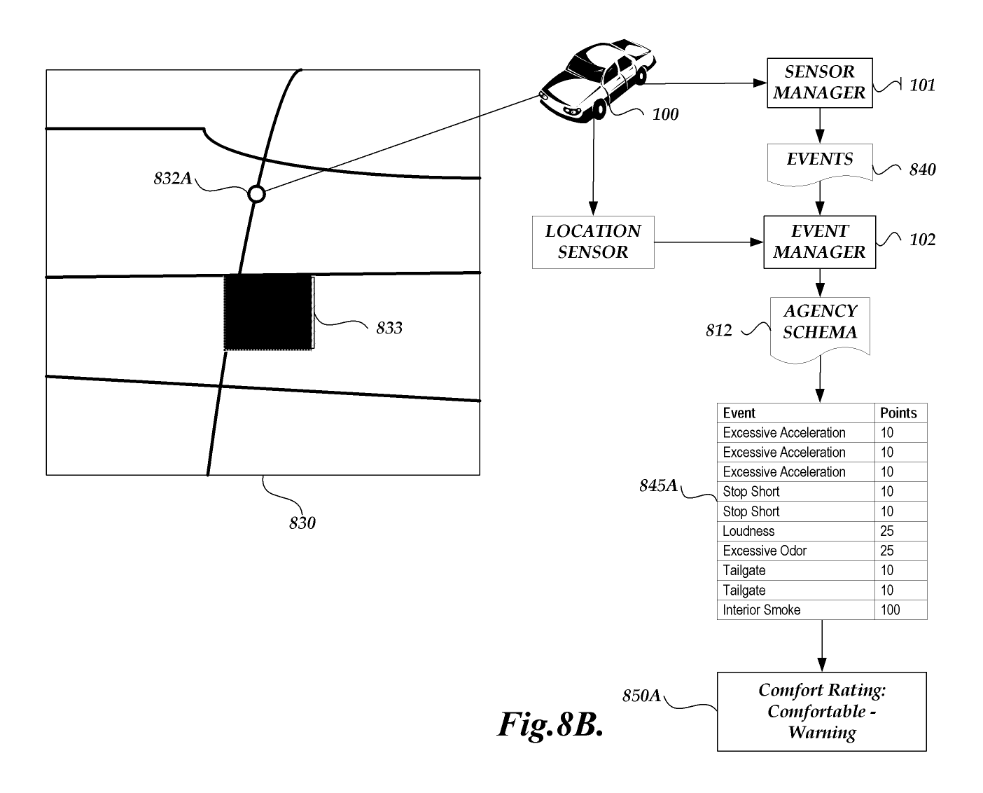

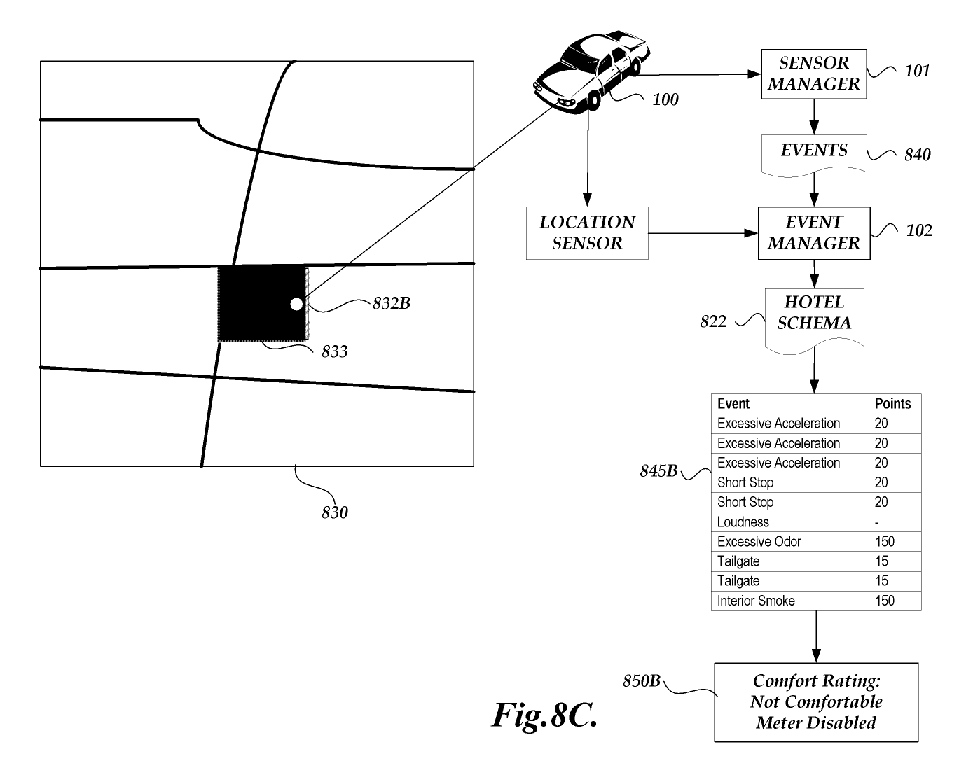

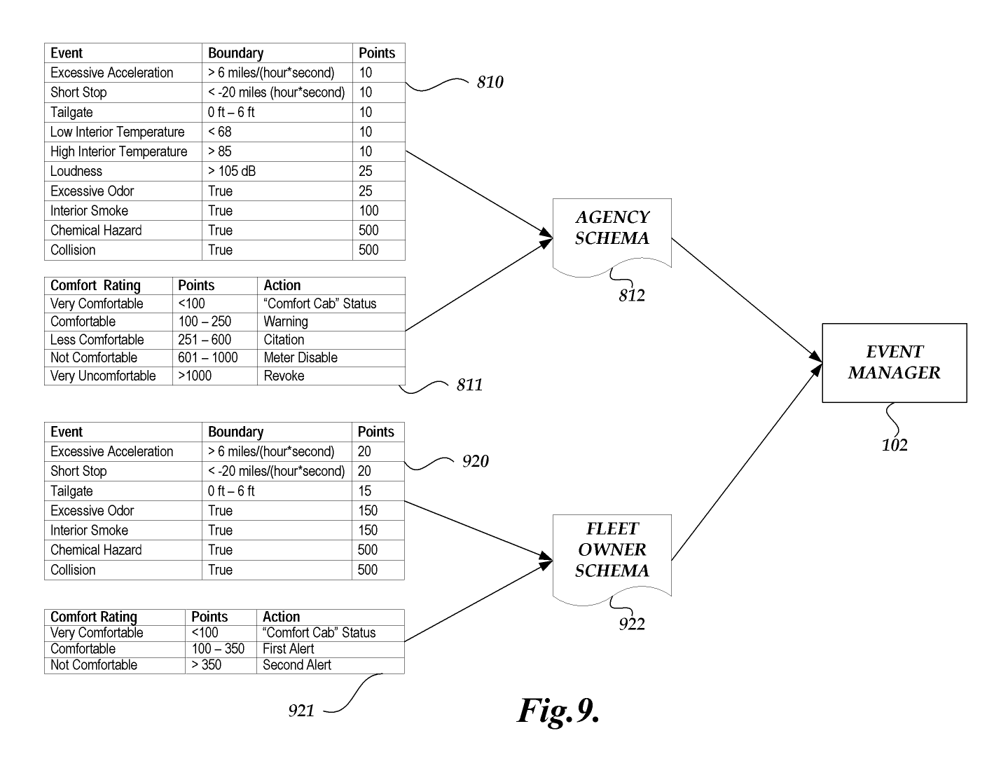

The user interface 700 may also permit, in some embodiments, a venue to define which driver input values are to be used to calculate the remedial action thresholds and the severity levels of those driver input values. The user interface 700 may include drop down list 705 that may provide a list of driver input events. In some embodiments, the drop down list 705 may be populated with the list of driver input events defined by the regulatory agency model (see, FIG. 8A and FIG. 9). Using drop down list 705, a venue may select a driver event type to add to the list of event types 708, that are used to calculate a driver's aggregate risk level. For example, in the embodiment of FIG. 7, a user has selected the “excessive acceleration”, “short stop” and “collision” driver input events to use when determining if a driver should be able to engage passenger fares at 123 Las Vegas Blvd. South. The user has also defined severity levels of 10, 10 and 500 to the selected driver input events, respectfully. A user may add additional drive input events by selecting one from drop down list 705, entering a severity value in point value text field 706 and selecting the Add button 707. If a user would like to remove one of the driver input values from the event type list 708, the user may select the driver input event from the table and press the Delete button 709.

### Example Embodiment in Operation

FIGS. 8A, 8B and 8C illustrate one embodiment of a method for regulating driver input choices in for-hire vehicles in operation. The method described in FIGS. 8A, 8B, and 8C may be implemented by one or more of the systems described above. Further, the embodiment of FIGS. 8A, 8B and 8C is illustrative only and certain aspects of the embodiment may be modified and a similar or substantially similar result may be achieved. For example, defined driver input events, boundary values or point values may vary from the illustrative embodiment of FIGS. 8A, 8B and 8C without limiting the scope or result of the method.

FIG. 8A illustrates an embodiment of two driver input models that may be used to regulate driver input choices: an agency model 810, 811 and a private party model 820, 821. Each model may comprise two sets of data. The first set of data may correspond to driver input event definitions while the second may correspond to comfort or safety levels associated with actions that may be taken with respect to drivers based on the aggregation of their driver input events. The agency model 810, 811 may advantageously be a model that has been created by a regulatory agency that regulates and controls the FHVs in operation within the jurisdiction. The agency model may be created for public policy reasons to help insure the safety and comfort of passengers traveling within FHVs. The private party model 820, 821 may be a model created by a private party that would like to insure the safety and comfort of those individuals that may be picked up at the private party's place of business. For example, the private party model may be created by a hotel that would prefer that only those drivers offering the most comfortable experience pick up passengers at the hotel. Although the embodiment of FIG. 8A uses a hotel as an example of a private party, other private parties may create their own models. For example, models may be created by casinos, entertainment venues, airports, train stations, or any other place of business. In addition, the private party model may be created by a company that owns and manages a fleet of FHVs to insure that its drivers are offering the highest quality of service to passengers.

In the illustrative embodiment of FIG. 8A, the agency model comprises driver input data 810. The driver input data 810 may comprise one or more driver input choices the regulatory agency has identified as affecting passenger comfort and safety. For example, driver input data 810 includes the following driver input choices: excessive acceleration, short stop (excessive deceleration or the driver choosing to slam on breaks), tailgate (the driver choosing to follow too close to the vehicle in front of him), low interior temperature (the driver choosing not to provide adequate heat), high interior temperature (the driver choosing not to provide adequate air conditioning), loudness (the driver choosing not to control the volume of the radio or choosing to take a route near loud noises), excessive odor (the driver not choosing to remove foul odors from the vehicle), interior smoke (the driver choosing to smoke in the FHV while traveling with passengers), chemical hazard (the driver choosing to unnecessarily introduce hazardous chemicals into the vehicle), and collision.

Each driver input choice or event may be associated with a boundary value. The boundary value may be the value that when exceeded, triggers the creation of an event by the sensor manager as described above. For example, for the event “Short Stop”, if the driver slams on the breaks and causes acceleration that is greater than negative 20 miles per hour-second (or a deceleration that is greater than 20 miles per hour-second), a driver input event will be recorded for the driver. Some boundary values are quantitative, that is, the sensor that measures the driver input value creates a quantitative value that may be reported to the sensor manager, which may then determine if a driver input value may need to be created. For example, a visual or sonar sensor that may be used to detect tailgating may produce a distance value, such as three feet, and the sensor manger may compare the detected value to the boundary value to determine if a driver input event should be recorded. Boundary values may also be binary thereby creating a driver input event when the sensor detects the presence of a condition. For example, a smoke sensor may only output a signal when it detects the presence of smoke. Thus, the regulatory agency would define the boundary value of “Interior Smoke” to be “True” and an interior smoke driver input event may be created anytime the sensor detects the presence of smoke.

In the illustrative embodiment of FIG. 8A, the driver input data 810 may also associate a point value with each driver input choice. The point value is the number of points that may be assigned to the driver when a driver input event is created in reaction to a choice of the driver that was detected by a sensor. For example, when the driver chooses to accelerate quickly, a sensor may detect that the driver is accelerating at a rate of 8 miles per hour-second. Since 8 miles per hour exceeds the boundary value for an Excessive Acceleration event, the driver may be assessed 10 points. Accumulated points may be used when determining a driver's Comfort Rating. In some embodiments, the driver input data 810 may define driver input events of the same type, but of different severity. For example, the driver input data 810 may include two Excessive Acceleration Events. The first may be assigned 10 points and may have a boundary value of 6 miles per hour-second. The second may be assigned 15 points and may have a boundary value of 10 miles per hour-second.

In the illustrative embodiment of FIG. 8A, the agency model may also comprise comfort rating data 811. The comfort rating data 811 may be used to determine actions the regulatory agency may take with respect to a driver based on upon the driver's input choices. The comfort rating data 811 may include one or more comfort ratings. The comfort ratings may serve as an approximation of the type of comfort the driver provides to passengers. For example, comfort rating data 811 includes the following comfort ratings: “Very Comfortable,” “Comfortable,” “Less Comfortable,” “Not Comfortable” and “Very Uncomfortable.” For each comfort rating, the regulatory agency may define an action that may be taken with respect to the driver. In some cases, the action is positive so as to encourage drivers to provide safe and comfortable service to passengers. For example, in FIG. 8A, the regulatory agency will grant the driver “Comfort Cab” status to a driver that has less than 100 points. The regulatory agency may bestow special benefits to the driver when they are awarded “Comfort Cab” status. For example, the status may be displayed on the cab using a dynamic display or the driver may be granted priority when waiting for passengers in a for-hire vehicle wait area, such as the airport. In other cases, the action taken by the regulatory agency may be negative or punitive in nature. For example, in FIG. 8A, the regulatory agency will disable the driver's meter once the driver has accumulated 601 points. In addition, the regulatory agency may bestow special benefits or recognition to a driver for remaining that the “Very Comfortable” comfort level for a period of time. For example, the regulatory agency may award a certificate to drivers who have maintained the “Very Comfortable” comfort level for 1 year, 2 years, or 5 years.

Once the regulatory agency decides on the agency model, it may embody the model in an agency schema 812. The agency schema 812 may be a document that specifies to a computer system the definition of the agency model. As used herein, the term “document” when used with respect to schemas may be any file, object, data structure, or collection of bytes that may be used to communicate data between computing systems. For example, a document may be a text file, a serialized object, or a byte stream. The agency schema 812 may be file, such as XML file, a configuration file in Unicode or ASCII format, for example. The agency schema may also be a serialized object that may be transmitted between computing systems. Thus, once the regulatory agency decides on the agency model, a computer operator working on behalf of the regulatory agency may create a configuration file that is then deployed to each event manager throughout the system. In some embodiments, a user interface may be used to create the schema. For example, private parties may use a user interface similar to the user interface defined in FIG. 7 to define private party models.

The illustrative embodiment of FIG. 8A also shows a private party model 820, 821. In operation, the private party model works in conjunction with the regulatory agency model to provide a multi-layered approach to regulating driver input choices. When a private party defines a driver input model, the model may only apply to a smaller area within the regulatory agency's jurisdiction of control, or may only apply to a subset of drivers regulated by the regulatory agency. For example, if the private party is a hotel, the hotel's driver input model may only apply to drivers when they are attempting to pick up passengers at the hotel. In addition, if a private party is a company that owns and operates a fleet of FHVs, the company's driver input model may only apply to those drivers driving the company's vehicles.

In the embodiment of FIG. 8A, a hotel has decided to define a private party driver input model in an effort to ensure its guests are served with high quality transportation services. The hotel has defined driver input data 820, which contains a subset of the driver input events listed in the agency's driver input data 810. While the hotel driver input data 820 is less restrictive in that it is monitoring less driver input choices, it is more restrictive in the sense that for some of the driver input choices the model monitors, higher points values are associated with the driver input events. For example, the hotel has determined that when a driver's choices generate an “Excessive Odor” event, the driver should be assessed 150 points, but at the regulatory agency level the driver is only assessed 25 points. Accordingly, the hotel has created an alternative definition of “comfort” as compared to the regulatory agency; the hotel's definition of comfort is placed more weight on the presence of foul odors than the regulatory agency. The flexibility of private party models advantageously provide private parties, such as the hotel, the ability to respond to customer's demands with respect to how the customer's may define comfortable and safe travel in a FHV. The private party model may also comprise private comfort rating data. In the example of FIG. 8A, the hotel has defined private party comfort data 821 which defines the comfort levels, points values and actions that may be applied to drivers when the arrive at the hotel to pick up passengers.

Once the hotel defines its private party model, it may create a hotel schema 822. The hotel schema 822 may be of the same format as described above with respect to the agency schema. Once the hotel defines the hotel schema 820, it may be deployed to the event managers in operation within the jurisdiction.

While FIG. 8A illustrates the hotel has defined private party driver input data 820 and private party comfort level data 821, in other embodiments of private party models, either the driver input data may not be defined or the comfort level data may not be defined. In such cases, the regulator agency's model data may be used to determine comfort levels. For example, if a private party defines driver input data, but does not define comfort level data, the comfort level data of the regulatory agency will be used to complete the private party model. Further, if the private party defines comfort level data, but does not define driver input data, then the regulatory agency's driver input data will be used to complete the private party data. In other words, the regulatory agency's driver input model serves as the default model for a jurisdiction and private party models may override some, or all, of that model in certain circumstances. Since the application of driver input models may depend on the location of the driver (whether they are at a site has defined a private party model or not), a driver's comfort level may vary from place to place. An example describing when a driver may be of different comfort levels is illustrated in FIGS. 8B and 8C.

FIG. 8B illustrates one embodiment of a process for determining a driver's comfort rating based on an agency schema. Region 830 is an area under the control of the regulatory agency that defined the agency model of FIG. 8A. FHV 100 is traveling within the region 830, but is not at the hotel 833. The FHV 100 has accumulated several driver input events 840. For example, FHV 100 has accumulated three excessive acceleration events, two stop short events, a loudness event, an excessive odor event, two tailgate events, and an interior smoke event. When FHV is in location 832A, the event manager 102 may apply the agency schema 812 to the events 840, the event manager 102 to calculate point values 845A, resulting in comfort rating 850A. Accordingly, when FHV 100 is at location 832A, the driver's comfort rating is “Comfortable,” which results in a warning to the driver.

FIG. 8C illustrates one embodiment of a process of determining a driver's comfort rating based on a private party schema. In the illustrative embodiment of FIG. 8C, the private party schema is the hotel schema 822. In FIG. 8C, FHV 100, at location 832B is at the hotel 833. The FHV 100 has the same events 840 as in FIG. 8B. However, here, in FIG. 8C, the event manager 102, after receiving the FHV 100's location from the location sensor, determines that the hotel schema 822 should be applied to the events 840, as opposed to the agency schema 812. The result is point values 845B. Point values 845B results in higher point values for the excessive acceleration events, the short stop events, the excessive odor event, the tailgate events, and the interior smoke event. Since the hotel schema did not define a value for the loudness input event, no points are applied to the driver for this event. The result is a comfort rating 850B of “Not Comfortable,” Due to the driver's comfort rating at the hotel, he cannot first engage his meter, and therefore, cannot accept passenger fares at the hotel.

The example depicted in FIGS. 8A, 8B, and 8C illustrate that while a driver may still be able to pick up passengers under the regulatory agency's driver input model, the driver cannot accept passenger fares at the hotel. Thus, the hotel has affectively controlled the quality of the drivers who may pick up visitors of the hotel, at the hotel.

FIG. 9 illustrates an embodiment of two driver input models that may be used to regulate driver input choices: an agency model 810, 811 and a private party model 920, 921. As described above, each model may comprise two sets of data. The first set of data may correspond to driver input event definitions while the second may correspond to comfort or safety levels associated with actions that may be taken with respect to drivers based on the aggregation of their driver input events. The agency model 810, 811 may be a model that has been created by regulatory agency that regulates and controls the FHVs in operation within the jurisdiction. The private party model 820, 821 may be a model created by a private party and, as described above, may work in conjunction with the agency model.

In the embodiment of FIG. 9, the private model is a model developed by an owner or operator of fleet of FHVs (“fleet owner”). It may be advantageous to allow a fleet owner to develop its own private party model in order to monitor the driver input choices of the drivers it employs (or enters into contract with to operate the fleet owner's FHVs) so that the fleet owner may identify those drivers that may be in danger of receiving remedial actions from the regulatory agency and preemptively take its own action on those drivers before they have accumulated enough driver input events to warrant a remedial action from the regulatory agency. The definition of a private party model by a fleet owner also advantageously allows for the fleet owner to address public comfort and safety concerns prior to intervention on the part of the regulatory agency. In addition, in embodiments where the regulatory agency may take actions at the fleet owner (or “driver group”) level, the definition of a private party model by the fleet owner advantageously provides the fleet owner with a method of taking the necessary steps to reward drivers that are performing at the highest comfort and safety levels and take action against those drivers that are not performing at high comfort and safety levels and to possibly prevent remedial action against the fleet owner by the regulatory agency such as the assessment of fines.

In the illustrative embodiment of FIG. 9, the private party model 920 comprises fleet owner driver input data 920 and fleet owner comfort rating data 921. Fleet owner driver input data 920 serves substantially the same purpose as private party input data 820 described above with respect to FIG. 8A. For example, fleet owner driver input data 920 may be one or more driver input events defined by the fleet operator as driver input events of interest, and the fleet operator may assign different point values to the driver input events than the regulatory agency. In addition, the fleet owner may also define fleet owner comfort rating data 921 that defines different comfort rating levels for the drivers that operate the fleet owner's FHVs. The fleet owner comfort rating data 921 may also define actions that may be taken when a driver accumulates a certain number of points under the private party model 920. For example, in the comfort rating data 921, a driver is permitted to display a “Comfort Cab” status rating when he is operating at the “Very Comfortable” level, the fleet owner is provided with a First Alert when the driver is operating at the “Comfortable” level, and the fleet owner is provided with a Second Alert with the driver is operating at the “Not Comfortable” level.

As shown in FIG. 9, the fleet owner may define its private party model so that it is alerted when drivers reach a certain comfort level. Alerts advantageously provide notice to fleet owners, which may then choose a course of action as a result of receiving the alert. For example, in the comfort rating data 921 of FIG. 9, the fleet owner has defined its model such that it will receive a First Alert when a driver has accumulated more than 100 points and a Second Alert with the driver has accumulated more than 350 points. Once the fleet owner receives the alert, it may choose to take a variety of actions. For example, the fleet owner may restrict the shifts of the driver, warn the driver about this driving habits, or suspend the driver for a period of time from operating the fleet owner's FHVs. In some embodiments, the First Alert and the Second Alert may be in the form of an email to the an email address provided by the fleet owner. In other embodiments, the alert may be a text message or phone call.

Once the fleet owner defines its private party model, it may create a fleet owner schema 922. The fleet owner schema 922 may be of the same format as described above with respect to the agency schema and the hotel schema of FIG. 8A. Once the fleet owner creates the fleet owner schema 920, it may be deployed to the event managers in operation within the jurisdiction.

### Conclusion

All of the methods and tasks described herein may be performed and fully automated by a computer system. The computer system may in some cases include multiple distinct computers or computing devices (e.g., physical servers, workstations, storage arrays, etc.) that communicate and interoperate over a network to perform the described functions. Each such computing devices typically includes a processor (or multiple processors) that executes program instructions or modules stored in a memory or other non-transitory computer-readable storage medium. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices such as solid state memory chips and/or magnetic disks, into a different state.

In addition, the methods described herein may be executed on suitable computing devices in response to execution of software instructions or other executable code read from a non-transitory tangible computer readable medium, computer readable storage or computer storage device. A computer readable medium is a data storage device that can store data that is readable by a computer system. The term “non-transitory,” as used in conjunction with tangible computer readable medium, computer readable storage, computer storage device, and the like, excludes only propagating transitory signals per se from the scope of these terms. Thus, “non-transitory” does not relinquish rights to all standard computer-readable media that are not solely propagating transitory signals per se. Examples of computer readable mediums include read-only memory, random-access memory, other volatile or non-volatile memory devices, CD-ROMs, magnetic tape, flash drives, and optical data storage devices.

The various computing systems described herein may be IBM, Macintosh or Linux/Unix compatible. The various computing systems may, in some embodiments, include one or more central processing units (“CPU”), which may include one or more conventional or proprietary microprocessors. The various computing systems may further include memory, such as random access memory (“RAM”) for temporary storage of information and read only memory (“ROM”) for permanent storage of information, and a data store, such as a hard drive, diskette, or optical media storage device. Embodiments of the data store may store data in databases, flat files, spreadsheets, or any other data structure known in the art. Typically, the modules of the various computing systems are in communication with one another via a standards based bus system. In different embodiments, the standards based bus system could be Peripheral Component Interconnect (PCI), Microchannel, SCSI, Industrial Standard Architecture (ISA) and Extended ISA (EISA) architectures, for example. In another embodiment, The various computing systems leverage computing and storage services available over the Internet (cloud computing).

The various computing systems may be generally controlled and coordinated by operating system software, such as the Windows 95, 98, NT, 2000, XP, Vista, Linux, SunOS, Solaris, PalmOS, Blackberry OS, or other compatible operating systems. In Macintosh systems, the operating system may be any available operating system, such as MAC OS X. In another embodiment, the various computing systems may be controlled by a proprietary operating systems, that is one that had been custom made for the purposes of embodying the systems and methods described herein. Conventional operating systems control and schedule computer processes for execution, perform memory management, provide file system, networking, and I/O services, and may provide a user interface, such as a graphical user interface (“GUI”) for display, among other things.

The various computing systems may also include one or more commonly available I/O devices and interfaces, such as for example, a printer, buttons, a keyboard, a LED display, a monitor, a touchpad, a USB port, a RS 232 port and the like. In one embodiment, the I/O devices and interfaces include one or more display devices, such as a monitor, that allows the visual presentation of data to a user. The I/O devices and interfaces may provide a communication interface to various external devices. The various computing systems may be in communication with a network, and the network may be any combination of one or more LANs, WANs, or the Internet, for example. The communications interface may also include, for example, ports for sending and receiving data such as a USB port or an RS 232 port.

The various computing systems may also include several application modules that may be executed by the CPU. The software code of the modules may be stored on a tangible computer-readable medium such as for example, RAM or ROM. In general, the word module, as used herein, refers to logic embodied in hardware or firmware, or to a collection of software instructions stored on a non-transitory and/or tangible computer-readable storage, possibly having entry and exit points, written in a programming language, such as, for example, C, C++, C#, or Java. A software module may be compiled and linked into an executable program, installed in a dynamic link library, or may be written in an interpreted programming language such as, for example, BASIC, Perl, or Python. Software modules may be callable from other modules or from themselves, and/or may be invoked in response to detected events or interrupts. Software modules may be stored in any type of computer-readable storage, such as a memory device (e.g., random access, flash memory, and the like), an optical medium (e.g., a CD, DVD, BluRay, and the like), firmware (e.g., an EPROM), or any other storage medium. The software modules may be configured for execution by one or more CPUs in order to cause computing systems described herein.

It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

The foregoing description details certain embodiments of the invention. It will be appreciated, however, that no matter how detailed the foregoing appears in text, the invention can be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A method of a regulating a driver of a for-hire vehicle, the method comprising:
receiving, by a computer system, current sensor data providing information related to a passenger's experience as a rider in a for-hire vehicle describing a change in state of a for-hire vehicle from one or more sensors;
associating, by the computer system, the sensor data with the for-hire vehicle;
determining, by the computer system, a current qualitative value associated with the current sensor data;
determining, by the computer system, whether to execute an action based at least in part on the determined current qualitative value and one or more past qualitative values associated with the for-hire vehicle, wherein the one or more past qualitative values have been determined based at least in part on received past sensor data; and
executing the action.

2. The method of claim 1 wherein the one or more sensors is installed in the for-hire vehicle.

3. The method of claim 1 wherein the sensor data comprises an indication of the acceleration of the for-hire vehicle.

4. The method of claim 1 wherein the sensor data comprises an indication of the interior temperature of the for-hire vehicle.

5. The method of claim 1 wherein the sensor data comprises an indication of the sound level in the interior of the for-hire vehicle.

6. The method of claim 1 wherein the sensor data comprises an indication of the presence of smoke inside the for-hire vehicle.

7. The method of claim 1 wherein the action comprises providing information regarding the quality of service prospective passengers of the for-hire vehicle may expect.

8. The method of claim 1 wherein the action comprises a warning to the driver of the for-hire vehicle.

9. The method of claim 1 wherein the action comprises preventing a meter associated with the for-hire vehicle to become first engaged.

10. The method of claim 1 wherein the action comprises issuing a fine to the driver of the for-hire vehicle.

11. A system for regulating a driver of a for-hire vehicle, the system comprising:
a processor;
a computer readable medium storing instructions performing the steps of:
receiving sensor data providing information related to a passenger's experience as a rider in a for-hire vehicle;
determining a current qualitative value associated with the sensor data; and
determining whether to execute an action based at least in part on the determined current qualitative value and one or more past qualitative values associated with the for hire vehicle, wherein the one or more past qualitative values have been determined based at least in part on received past sensor data.

12. The system of claim 11 wherein the sensor data comprises an indication of the acceleration of the for-hire vehicle.

13. The system of claim 11 wherein the sensor data comprises an indication of the interior temperature of the for-hire vehicle.

14. The system of claim 11 wherein the sensor data comprises an indication of the sound pressure level in the interior of the for-hire vehicle.

15. The system of claim 11 wherein the sensor data comprises an indication of the presence of smoke inside the for-hire vehicle.

16. The system of claim 11 wherein the action comprises providing information regarding the quality of service prospective passengers of the for-hire vehicle may expect.

17. The system of claim 11 wherein the action comprises a warning to the driver of the for-hire vehicle.

18. The system of claim 11 wherein the action comprises preventing a meter associated with the for-hire vehicle to become first engaged.

19. The system of claim 11 wherein the action comprises issuing a fine to the driver of the for-hire vehicle.

20. A method of a regulating a driver of a for-hire vehicle comprising:
receiving, by a computer system, a request for authorization to initiate a passenger fare from a for-hire vehicle meter installed in a for-hire vehicle;
accessing, by the computer system, one or more driver input events associated with the for-hire vehicle, the one or more driver input events comprising an indication of readings from one or more sensors;
determining, by the computer system, whether to authorize the for-hire vehicle meter based at least in part on the one or more driver input events;
communicating, by the computer system, the authorization to the for-hire vehicle meter.

21. The method of claim 20 wherein the sensor data comprises an indication of at least one of: acceleration of the for-hire vehicle, the interior temperature of the for-hire vehicle, the sound pressure level in the interior of the for-hire vehicle, an indication of the breaking frequency of the for-hire vehicle, or an indication of the presence of smoke inside the for-hire vehicle.

22. A method of providing a quality of service rating associated with a for-hire vehicle comprising:
receiving, by a computer system, current sensor data providing information related to a passenger's experience as a rider in a for-hire vehicle describing a change in state of a for-hire vehicle from one or more sensors installed in the for-hire vehicle;
associating, by the computer system, the sensor data with the for-hire vehicle;
determining, by the computer system, a current qualitative value associated with the current sensor data;
determining, by the computer system, one or more past qualitative values associated with the for-hire vehicle, wherein the one or more past qualitative values have been determined based at least in part on received past sensor data; and
determining, by the computer system, a rating for the for-hire vehicle, the rating based at least in part on the aggregate of the one or more past qualitative values and the current qualitative value.

23. The method of claim 22 wherein the sensor data comprises an indication of at least one of: acceleration of the for-hire vehicle, the interior temperature of the for-hire vehicle, the sound pressure level in the interior of the for-hire vehicle, an indication of the breaking frequency of the for-hire vehicle, or an indication of the presence of smoke inside the for-hire vehicle.

24. The method of claim 22 further comprising:
executing, by the computer system, an action based at least in part on the rating.

25. The method of claim 24 wherein the action comprises a warning to the driver of the for-hire vehicle.

26. The method of claim 24 wherein the action comprises preventing a meter associated with the for-hire vehicle to become first engaged.

27. The method of claim 21, further comprising:
receiving, by the computer system, a reservation request for a for-hire vehicle from a prospective passenger, the reservation request comprising a desired rating providing a minimum level of quality of service that is acceptable to the prospective passenger; and.
generating, by the computer system, a reservation for a for-hire vehicle based on the reservation request wherein the reserved for-hire vehicle has a rating that satisfies the minimum acceptable level of quality of service.

28. The method of claim 27 further comprising dispatching, by the computer system, a for-hire vehicle based on the reservation.

29. A system of providing a quality of service rating associated with a for-hire vehicle comprising:
a processor;
a computer readable medium storing instructions performing the steps of:
receiving current sensor data providing information related to a passenger's experience as a rider in a for-hire vehicle describing a change in state of a for-hire vehicle from one or more sensors installed in the for-hire vehicle;
associating the sensor data with the for-hire vehicle;
determining a current qualitative value associated with the current sensor data;
determining one or more past qualitative values associated with the for-hire vehicle, wherein the one or more past qualitative values have been determined based at least in part on received past sensor data; and
determining a rating for the for-hire vehicle, the rating based at least in part on the aggregate of the one or more past qualitative values and the current qualitative value.

30. The system of claim 29 wherein the sensor data comprises an indication of at least one of: acceleration of the for-hire vehicle, the interior temperature of the for-hire vehicle, the sound pressure level in the interior of the for-hire vehicle, an indication of the breaking frequency of the for-hire vehicle, or an indication of the presence of smoke inside the for-hire vehicle.

31. The system of claim 29 wherein the instructions stored by the computer readable medium further perform the step of executing an action based at least in part on the rating.

32. The system of claim 31 wherein the action comprises a warning to the driver of the for-hire vehicle.

33. The system of claim 31 wherein the action comprises preventing a meter associated with the for-hire vehicle to become first engaged.

34. The system of claim 29 wherein the instructions stored by the computer readable medium further perform the steps of:
receiving a reservation request for a for-hire vehicle from a prospective passenger, the reservation request comprising a desired rating providing a minimum level of quality of service that is acceptable to the prospective passenger; and.
generating a reservation for a for-hire vehicle based on the reservation request wherein the reserved for-hire vehicle has a rating that satisfies the minimum acceptable level of quality of service.

35. The system of claim 35 wherein the instructions stored by the computer readable medium further perform the step of dispatching a for-hire vehicle based on the reservation.
